(19) United States
(12) Patent Application Publication
(10) Pub. No.: US 2026/0288750 A1
(43) Pub. Date: Sep. 24, 2026

(54) SYSTEM

(71) Applicant: SoftBank Group Corp., Tokyo (JP)

(72) Inventor: Masakazu ISHIDA, Tokyo (JP)

(73) Assignee: SoftBank Group Corp., Tokyo (JP)

(21) Appl. No.: 19/564,546

(22) Filed: Mar. 12, 2026

(30) Foreign Application Priority Data
Mar. 19, 2025 (JP) 2025-044483

(51) Int. Cl. G06F 16/25; G06F 16/22; G06F 16/23

(52) U.S. Cl. CPC G06F 16/258; G06F 16/2246; G06F 16/2365

(57) ABSTRACT

A system includes a processor that is configured to provide a graphical user interface through which a user inputs travel schedule information, a number of travelers, and a means of transportation, receive the input information from the user and store the input information in a database, and generate a prompt that instructs a generative artificial intelligence model to generate a travel plan based on the stored information, and generate the travel plan by using the prompt with the generative artificial intelligence model.

### CROSS-REFERENCE TO RELATED APPLICATION

This application is based on and claims priority under 35 USC 119 from Japanese Patent Application No. 2025-044483 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional travel planning systems typically rely on rule-based search engines and static databases to propose travel plans based on user input such as travel dates, number of travelers, and means of transportation. In such systems, the server generally retrieves pre-registered tour packages or simple combinations of transportation and accommodation options that match basic filter conditions. As a result, the proposed travel plans are often rigid, lack personalization, and do not flexibly reflect the user's detailed preferences or contextual information that can be inferred from the user's input. Furthermore, in conventional systems, the generation logic for travel plans is fixed by the system designer, making it difficult to adaptively improve plan quality or diversify suggestions without significant manual modification of the program or database. There is therefore a need for a system that can automatically generate flexible, rich, and personalized travel plans by effectively utilizing generative artificial intelligence models based on user-provided information, while maintaining a clear and controllable mechanism for how the generative artificial intelligence is prompted and used.

### SUMMARY

In order to solve the above-described problem, according to one aspect of the invention, there is provided a system comprising a processor, wherein the processor is configured to provide a graphical user interface through which a user inputs travel schedule information, a number of travelers, and a means of transportation, receive the input information from the user and store the input information in a database, and generate a prompt that instructs a generative artificial intelligence model to generate a travel plan based on the stored information, and generate the travel plan by using the prompt with the generative artificial intelligence model. The processor may be further configured to transmit the generated travel plan in a structured data format to a user terminal and cause the generated travel plan to be visually displayed on the user terminal. The processor may also be configured to include a prompt generation module that analyzes the input information from the user and generates, based on a result of the analysis, the prompt that instructs the generative artificial intelligence model to generate the travel plan, and create an optimal travel plan by using the prompt. By structuring the processing in this manner, the system can dynamically and automatically generate personalized travel plans that are tailored to the user's input and inferred preferences, while enabling the travel plans to be output in a machine-readable, structured format that can be easily rendered and further processed on the user terminal.

The term “system” refers to a combination of hardware and software components, including at least one processor, that cooperatively perform the functions described in the claims.

The term “processor” refers to one or more hardware processing units, such as a central processing unit (CPU), microprocessor, or special-purpose processing circuit, and includes any associated memory and control logic configured to execute instructions to perform the described functions.

The term “graphical user interface” refers to an interface presented on a display device that allows a user to input and receive information through visual elements such as windows, icons, menus, buttons, text boxes, and other graphical components.

The term “user” refers to a person who operates a terminal or device to input travel-related information, receive a generated travel plan, and view or otherwise use the travel plan.

The term “travel schedule information” refers to information indicating at least a start date and an end date of a trip, and may further include intermediate dates, times, or other temporal constraints related to the trip.

The term “number of travelers” refers to information indicating a count of persons for whom the travel plan is to be generated, including the user and optionally additional accompanying persons.

The term “means of transportation” refers to one or more modes or types of transport to be used in the travel plan, such as airplane, train, bus, ship, private car, rental car, or any combination thereof.

The term “input information” refers to the information provided by the user through the graphical user interface, including at least the travel schedule information, the number of travelers, and the means of transportation, and optionally additional travel-related preferences or constraints.

The term “database” refers to any structured data storage system, such as a relational database, key-value store, or other persistent storage, in which information including user input and travel-related data is stored and managed.

The term “generative artificial intelligence model” refers to a machine learning model configured to generate content, such as text or structured data, based on input data or prompts, and includes, for example, large language models, transformer-based models, or other neural network models capable of generating travel plans.

The term “prompt” refers to data, typically expressed as text or structured parameters, that specifies conditions, constraints, instructions, or context and is supplied as input to the generative artificial intelligence model to cause the generative artificial intelligence model to generate a travel plan.

The term “travel plan” refers to information representing at least one proposed itinerary for a trip, including one or more elements such as destinations, dates, times, transportation segments, accommodations, activities, and associated descriptions or conditions.

The term “structured data format” refers to a machine-readable representation of data having a defined structure, such as JSON, XML, CSV, or another format that allows individual elements of a travel plan to be programmatically identified, parsed, and processed.

The term “user terminal” refers to an electronic device operated by the user, such as a personal computer, smartphone, tablet, or other computing device, that is capable of displaying the graphical user interface and receiving the structured travel plan data from the system.

The term “visually displayed” refers to presentation on a display screen or output device in a human-perceivable visual form, including text, icons, images, or graphical components representing at least part of the travel plan.

The term “prompt generation module” refers to a functional component implemented by hardware, software, or a combination thereof, executed by the processor, that analyzes the user's input information and generates the prompt supplied to the generative artificial intelligence model.

The term “analysis of the input information” refers to processing the user's input information, including operations such as parsing, classifying, extracting features, identifying constraints or preferences, and deriving additional conditions used to generate or refine the prompt.

The term “optimal travel plan” refers to a travel plan that is determined, according to one or more criteria specified or implied by the system or the user, to best satisfy the user's requirements or preferences among a plurality of candidate plans generated or considered by the system.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

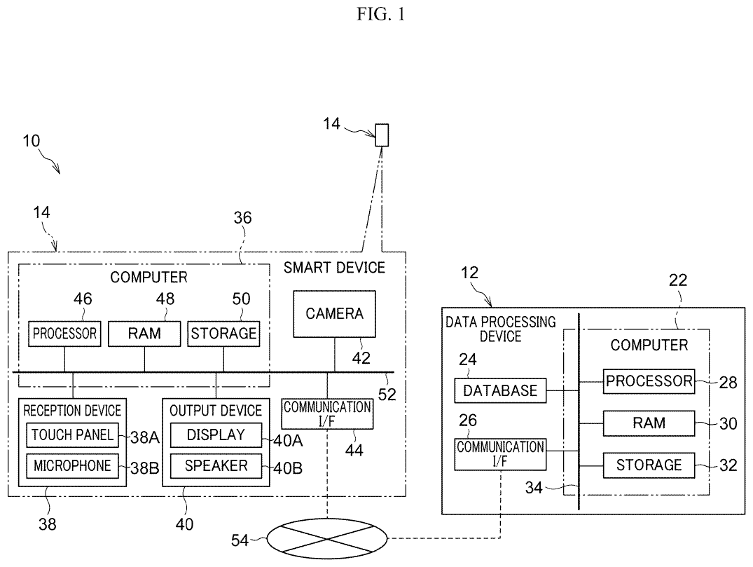

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

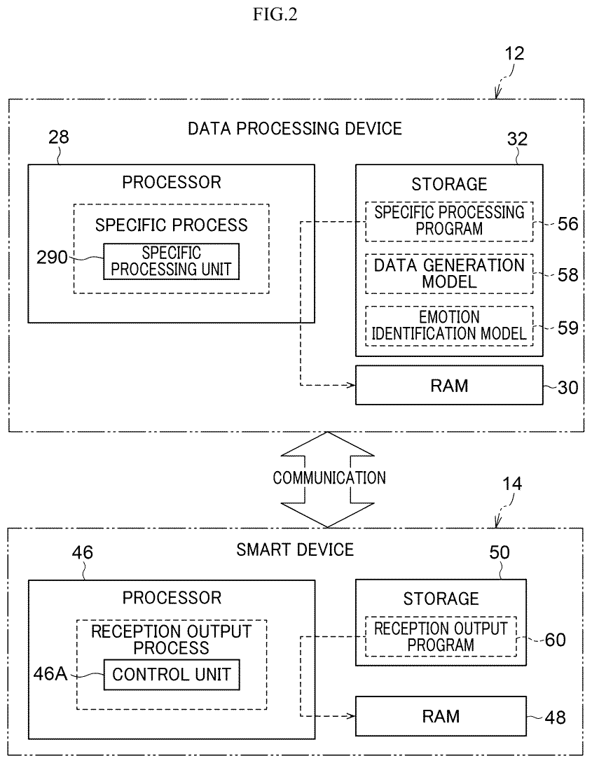

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented travel planning systems typically rely on fixed rule engines or manually crafted templates to generate itineraries from user input. In such systems, a server receives basic travel parameters, such as dates and locations, and applies predetermined logic to select points of interest and to construct a sequence of activities. This approach suffers from several technical limitations. First, the server is required to execute complex, domain-specific application logic on a per-request basis, which increases processing load and makes it difficult to scale as the number of users and the diversity of travel scenarios grow. Second, the server often handles unstructured or semi-structured text directly, without transforming the input or output into well-defined structured formats, which complicates downstream processing, storage, and rendering on user devices. Third, when large-scale generative AI models are integrated in a naive manner, the server typically passes raw user text directly to the model and receives free-form output. As a result, the server cannot reliably control the structure, granularity, or constraints of the generated content, and must perform expensive, error-prone parsing to extract useful itinerary data.

From the perspective of computer technology, these limitations manifest as inefficiencies in how the server allocates computation between prompt construction, model inference, and post-processing, and as poor utilization of structured data representations in the communication between components. In particular, existing systems do not systematically convert user inputs into a structured, normalized data set before constructing a prompt sentence for a generative AI model, nor do they consistently convert the model's natural language output back into a hierarchical structured data format optimized for machine processing and dynamic rendering on a user terminal. This leads to increased CPU usage for natural language parsing, higher memory consumption for handling unstructured text blobs, and latency overhead due to repeated ad hoc transformations. Furthermore, feedback loops in which the user refines the travel conditions typically require manual re-entry of data and ad hoc modification of prompts, preventing the server from programmatically optimizing prompt templates and constraint conditions over successive iterations.

Accordingly, there is a need for a computer-implemented technique that improves the way a server processes travel planning requests by: (i) normalizing user-provided travel conditions into a structured data set, (ii) automatically generating a controlled prompt sentence for a generative AI model based on the structured data set, (iii) converting the model's output into a hierarchical structured format suitable for efficient storage and rendering, and (iv) iteratively updating the prompt sentence and constraint conditions in response to user corrections. Such a technique should improve the efficiency, reliability, and controllability of server-side processing when integrating generative AI models into travel planning workflows.

The specific processing by the specific processing unit 290 of the data processing device 12 in Example 1 is realized by the following means.

The present invention provides a server comprising a processor configured to provide a screen-based input/output environment to a user terminal, receive travel condition information including a travel period, a number of participants, a travel mode, a departure location, and an arrival location from the user terminal via a communication protocol, convert the travel condition information into a normalized structured record and store the normalized structured record in a storage device, acquire the normalized structured record from the storage device and generate, based on the normalized structured record, a structured data set including at least a number of travel days, normalized travel locations, and a normalized travel mode, automatically generate a prompt sentence by inserting elements of the structured data set into predetermined positions of a sentence template to instruct a generative AI model to generate a travel itinerary plan, transmit the prompt sentence to the generative AI model via a communication interface and acquire a travel itinerary plan text generated by the generative AI model, analyze the travel itinerary plan text and convert the travel itinerary plan text into a hierarchical structured data format including, for each day, itinerary elements, time-based activity information, travel segments, and lodging candidates, convert the hierarchical structured data format into a data structure transmittable to the user terminal, and transmit the data structure to the user terminal, and further configured to, in response to correction input from the user terminal, update the sentence template and constraint conditions of the prompt sentence and re-transmit an updated prompt sentence to the generative AI model so as to iteratively optimize the travel itinerary plan. This enables an improvement in computer functionality by reducing server-side parsing complexity and processing overhead through consistent use of structured data representations, by programmatically controlling the behavior of the generative AI model via automatically constructed prompt sentences and constraint conditions, and by supporting an iterative feedback loop in which the server efficiently regenerates and refines itinerary data with reduced latency and improved reliability in the interaction between the server, the generative AI model, and the user terminal.

The term “system” refers to an information processing arrangement including at least one processor, at least one storage device, and at least one communication interface configured to execute the functions described in the claims.

The term “processor” refers to one or more hardware processing units, such as a central processing unit or a graphics processing unit, capable of executing instructions to perform data processing operations specified in software or firmware.

The term “user” refers to a human operator who interacts with the system to request generation, modification, or viewing of a travel itinerary plan.

The term “user terminal” refers to an electronic device operated by the user, such as a computing device, that includes a display, an input device, a communication interface, and a browser or application capable of presenting a screen-based input/output environment and communicating with the processor.

The term “screen-based input/output environment” refers to a graphical user interface rendered on a display of the user terminal, including one or more input controls and output display regions, through which the user can input travel condition information and view at least a portion of a travel itinerary plan.

The term “travel condition information” refers to input data provided by the user or the user terminal that specifies parameters of a travel request, including at least a travel period, a number of participants, a travel mode, a departure location, and an arrival location.

The term “travel period” refers to temporal information specifying at least a travel start date and a travel end date for a requested travel itinerary.

The term “number of participants” refers to a numerical value indicating a total count of travelers to be included in the travel itinerary plan.

The term “travel mode” refers to a classification of transportation type to be used in at least a portion of a trip, such as rail, air, road, or water transportation.

The term “departure location” refers to a geographic place, such as a city or region, from which a trip is initiated in a travel itinerary plan.

The term “arrival location” refers to a geographic place, such as a city or region, at which a trip is intended to terminate or at which a major segment of a trip is to be completed.

The term “communication protocol” refers to a set of rules and formats governing exchange of messages between the user terminal and the processor, including, for example, protocols layered on top of a network transport protocol.

The term “structured record format” refers to an organized data representation in which fields corresponding to elements of travel condition information are stored in a predefined schema, such as a table row or an object with named attributes.

The term “storage device” refers to a hardware memory component or subsystem, such as a non-volatile memory or a database system, capable of storing structured records and related data used by the processor.

The term “normalized structured record” refers to a structured record format in which values of travel condition information have been standardized or canonicalized according to predetermined rules, such as date normalization and location name normalization.

The term “structured data set” refers to a collection of data elements organized according to a defined structure that is derived from at least the normalized structured record and is suitable for use in generating a prompt sentence.

The term “number of travel days” refers to a derived numerical value representing a count of days between a travel start date and a travel end date, inclusive or exclusive, as determined by a predefined rule.

The term “normalized travel locations” refers to travel locations that have been standardized to a canonical representation, such as a standardized city name or code, for consistent internal processing.

The term “normalized travel mode” refers to a travel mode that has been standardized to a canonical representation, such as a normalized enumeration value indicating transportation type.

The term “sentence template” refers to a predefined text pattern including one or more placeholders into which elements of the structured data set can be inserted to form a complete prompt sentence.

The term “prompt sentence” refers to a text string constructed based on the sentence template and the structured data set, the text string being configured to instruct a generative AI model to generate or modify a travel itinerary plan.

The term “generative AI model” refers to a machine-learned model configured to generate natural language or structured outputs in response to an input prompt sentence, such as a neural network-based language model.

The term “model processing unit” refers to a logical or physical processing component associated with the generative AI model that receives a prompt sentence, performs inference using the model, and outputs generated content.

The term “communication interface” refers to a hardware and software combination configured to send and receive data between the processor and external entities, such as the generative AI model or the user terminal, over a communication path.

The term “travel itinerary plan” refers to an arrangement of travel-related activities, transportation segments, and lodging options over a travel period, organized for at least one participant.

The term “travel itinerary plan text” refers to natural language content output by the generative AI model that describes at least a portion of a travel itinerary plan.

The term “hierarchical structured data format” refers to a data representation in which itinerary elements are organized in multiple levels, such as days, time periods within days, and activities within time periods.

The term “itinerary element” refers to a unit of planning information within a travel itinerary plan, such as a day record, a time slot, a location, or an activity.

The term “time-based activity information” refers to data that associates a particular activity with a time period, such as morning, afternoon, or evening, or with a specific time range.

The term “travel segment” refers to a portion of travel between two locations, characterized by at least a start location, an end location, and optionally a travel mode or time.

The term “lodging candidate” refers to a proposed accommodation option for at least one night or time period within the travel itinerary plan.

The term “data structure transmittable to the user terminal” refers to a machine-readable representation, such as a structured message or object, derived from the hierarchical structured data format and suitable for transmission over the communication path to the user terminal.

The term “communication path” refers to one or more physical or logical channels over which data is exchanged between the processor, the generative AI model, and the user terminal.

The term “display element” refers to a graphical component, such as a text field, card, or list item, that is generated on the user terminal to visually represent a portion of the structured data format.

The term “correction input” refers to input data provided by the user via the screen-based input/output environment that modifies previously provided travel condition information or specifies additional constraints for the travel itinerary plan.

The term “constraint conditions” refers to rules or parameters specified in or associated with the prompt sentence that restrict or guide the behavior of the generative AI model, such as detail levels, types of activities, or limits on travel time.

The term “detail level of the travel itinerary plan” refers to a specification of granularity for the generated itinerary, such as inclusion or omission of fine-grained timing, descriptions, or alternative options.

The term “output format” refers to a structural or syntactic specification for the generated content from the generative AI model, such as a required hierarchical format, a list-based format, or a markup-based format.

The term “prompt generation functional unit” refers to a logical component implemented by the processor that constructs, modifies, and outputs prompt sentences, including associated constraint conditions, for input to the generative AI model.

The term “iteratively optimize” refers to a process in which the system repeatedly generates, evaluates, and refines a travel itinerary plan across multiple cycles of prompt sentence generation and model invocation, based at least on user feedback or updated constraints.

In one embodiment, a server includes a processor, a main memory, a non-volatile storage device, and a network interface card interconnected by a system bus. The processor is, for example, a multi-core central processing unit, and optionally cooperates with a graphics processing unit used for accelerating inference of a generative AI model. The storage device stores an operating system, a web application framework, a database management system, a model inference engine, and program modules implementing the functions described in the claims.

The server executes a web application framework such as a general server-side scripting framework to provide an HTTP(S)-based interface to a terminal. The server stores program instructions which, when executed by the processor, cause the server to generate hypertext documents defining a screen-based input/output environment. The terminal executes a web browser or a dedicated application to render this environment. The terminal includes a display, an input device such as a touch panel or keyboard, a local memory, and a communication interface. The terminal displays input controls for travel conditions and transmits user-provided data to the server over a network using a communication protocol such as HTTP over TCP/IP.

The user operates the terminal to input travel condition information. The terminal renders, on the display, text boxes, date selectors, numeric fields, and selection controls for travel modes, departure locations, and arrival locations. The user enters, for example, “2023 Dec. 1” as a travel start date, “2023 Dec. 5” as a travel end date, “4” as a number of participants, “Tokyo” as a departure location, “Kyoto” as an arrival location, and “Shinkansen” as a travel mode. The terminal converts these inputs into structured message fields and transmits them to the server as a request in a predefined message format, such as a JSON or form-encoded format, over the network.

The server receives the travel condition information via the network interface and stores the received data into the main memory. The server executes a validation module that checks, by explicit comparison and parsing operations, that dates follow a predetermined format, that the number of participants is a positive integer within an allowed range, and that travel modes match a list of supported modes. The server rejects invalid inputs and generates an error response, thereby preventing inconsistent or malformed data from entering subsequent stages of processing. This early validation reduces the number of exceptions in later modules and decreases the overall processing overhead.

The server converts valid travel condition information into a normalized structured record. The server uses a database client library to connect to a relational database system such as a generic SQL-compliant database running on the storage device. The server maps each field of the input, such as start date, end date, number of participants, departure location, arrival location, and travel mode, to columns in a database table. The server normalizes the data by converting free-form textual locations into canonical identifiers stored in a location master table, converting textual travel modes into normalized enumeration values, and computing a number of travel days from the start and end dates. The server stores the normalized structured record into the database using an insert operation and associates it with a unique trip identifier. This normalization and structured storage allow indexed queries and efficient retrieval, thereby improving data management and reducing query latency compared with ad hoc text storage.

The server retrieves the normalized structured record and constructs a structured data set in a data structure such as an in-memory object with explicit fields for the number of travel days, normalized origin and destination codes, normalized travel mode codes, and the number of participants. The server applies deterministic transformation rules to derive additional attributes, such as a classification of the group type (for example, “family,” “business,” or “couple”) based on the number of participants and optional age information, or a travel intensity level based on the number of days and distance between locations. By representing these attributes explicitly in a structured data set, the server can generate prompt sentences in a controlled manner without repeated parsing of unstructured text.

The server generates a prompt sentence for a generative AI model using a template-based prompt generation module. The server maintains several sentence templates in the storage device, each template including placeholders for structured data fields. The server selects a template according to predetermined rules, for example by matching the travel duration or travel mode. The server then inserts the values from the structured data set into the placeholders. For example, the server generates a prompt sentence such as:

“Please create a detailed 5-day travel plan for 4 people traveling from Tokyo to Kyoto by Shinkansen from 2023 Dec. 1 to 2023 Dec. 5. Include daily schedules with morning, afternoon, and evening activities, recommended sightseeing spots, meal suggestions, and hotel options near major attractions.”

In another example, the server generates a prompt sentence including structural constraints: “Based on the following conditions: departure city: Tokyo, destination city: Kyoto, dates: 2023 Dec. 1 to 2023 Dec. 5, number of travelers: 4, transportation: Shinkansen, please generate a travel itinerary that is output as plain text organized by ‘Day 1’, ‘Day 2’, . . . where each day contains a list of time slots (morning, afternoon, evening) and at least two suggested activities per time slot.”

The server uses string concatenation and formatting operations in the application layer to construct these prompt sentences from the template and the structured data set. Because the server centrally controls template selection and placeholder filling, the server reduces variability in the prompt structure and thereby reduces the complexity of parsing the model's output.

The server invokes a generative AI model to generate a travel itinerary plan text. In one embodiment, the generative AI model is implemented as a transformer-based neural network comprising an input embedding layer, multiple self-attention layers, feed-forward layers, and an output projection layer. The model parameters include learned weight matrices for attention and feed-forward projections, and bias terms, stored in a model file on the storage device or on a separate model server. The server transmits the prompt sentence to the model via an application programming interface. The server provides, as input, tokenized representations of the prompt sentence, where each token corresponds to a subword or word and is represented as a vector in an embedding space. The generative AI model processes the tokens by applying multi-head self-attention, where each attention head computes attention weights over the token sequence using queries, keys, and values derived from the embeddings. The model aggregates the weighted values, passes the result through the feed-forward layers, and iterates through multiple layers to compute hidden representations. The model then computes logits over a vocabulary and applies a softmax function to generate probability distributions for the next token. The model repeats this generation step until a termination condition is satisfied, such as generation of an end-of-sequence token or reaching a maximum length parameter provided by the server.

The server configures the generative AI model with specific inference parameters, such as temperature, top-k sampling, or nucleus sampling thresholds, to balance diversity and determinism of the generated itinerary plan text. By controlling these parameters, the server ensures that the travel itinerary plan text conforms to the structural and stylistic expectations implied by the prompt sentence. The server thus uses explicit algorithmic controls over the generative process rather than relying on arbitrary free-form generation.

The server receives the travel itinerary plan text from the generative AI model and stores it into memory. The server performs deterministic post-processing of the generated text using text analysis modules. For example, the server uses pattern matching algorithms and regular expressions to detect headings such as “Day 1,” “Day 2,” and “Day 3.” The server segments the text by these headings and further divides each day's segment into time slots based on keywords such as “morning,” “afternoon,” and “evening.” The server identifies activity descriptions, transportation descriptions, and lodging recommendations by matching lexical patterns or by applying a secondary, smaller classification model trained to label sentences according to categories such as activity, transport, or accommodation.

The server converts the segmented and labeled content into a hierarchical structured data format. The server creates a data structure in which the top level corresponds to days, each day contains a list of time slots, and each time slot contains a list of activities with associated metadata such as location names, approximate time ranges, and tags indicating type of activity. The server also extracts lodging candidates and associates them with particular days and locations. This conversion from unstructured text to a hierarchical format enables efficient indexing, filtering, and partial updates, and reduces the computational cost of repeated full-text parsing.

The server stores the hierarchical structured data format in the database or in a separate data store optimized for document or object storage. The server then converts this hierarchical data into a representation suitable for transmission to the terminal, such as a compact structured message format. The server reduces redundancy in this representation by replacing repeated location names or activity types with references or codes, which reduces payload size and therefore reduces communication load on the network.

The terminal receives the structured representation from the server and parses it into in-memory data structures. The terminal generates display elements based on this structure. The terminal creates, for example, a card component for each day, headings for each day, and nested lists for activities and lodging options. The terminal arranges these display elements on the screen according to a layout model and applies local style rules. The terminal updates the screen-based input/output environment without a full page reload, which reduces visual latency and improves user experience.

The user reviews the displayed travel itinerary plan and provides correction input. The terminal captures user edits, such as changing the number of activities per day or specifying a preference for certain types of attractions. The terminal transmits this correction input back to the server as updated travel condition information. The server updates the structured record with these corrections and invokes a prompt generation functional unit to adjust the sentence template and constraint conditions. For example, the server updates the prompt sentence to:

“Please regenerate the 5-day travel plan for 4 people traveling from Tokyo to Kyoto by Shinkansen from 2023 Dec. 1 to 2023 Dec. 5, limiting the number of activities to 3 per day and prioritizing historical sites over shopping. Maintain the output structure organized by ‘Day 1’, ‘Day 2’, etc., with morning, afternoon, and evening time slots.”

By programmatically modifying the template and constraints based on structured corrections, the server executes a feedback loop that iteratively optimizes the itinerary plan. The server thus reduces the need for manual re-entry of complete travel information and provides a controlled, repeatable mechanism for refinement.

From a technical standpoint, this architecture improves computer functionality in several ways. The server reduces processing load by transforming user inputs into normalized structured data before invoking the generative AI model, which minimizes the amount of unstructured text that must be parsed. The server reduces latency and CPU usage through deterministic segmentation of model outputs into a hierarchical structured data format that is directly consumable by the terminal. The server leverages prompt templates and explicit constraint conditions to shape the generative process, which yields outputs with predictable structural patterns and reduces errors in subsequent parsing. The server also improves data management by storing both normalized structured records and hierarchical itinerary structures in a database with explicit schemas and indexes, enabling efficient retrieval, update, and aggregation across multiple itineraries. This contrasts with conventional systems that store large text blobs without structure, which require expensive scanning and ad hoc parsing for each access.

Moreover, the generative AI model used by the server is trained using supervised or self-supervised learning on large corpora of travel-related text. During training, the model minimizes an objective function such as cross-entropy loss between predicted tokens and ground-truth tokens, using gradient-based optimization and weight updates such as stochastic gradient descent or its variants. The model's internal parameters encode latent relationships between travel activities, locations, and temporal patterns that are not explicitly encoded in traditional rule-based engines. The server exploits these learned relationships by providing structured, constraint-rich prompt sentences, which guide the model to produce coherent and contextually appropriate itineraries beyond what a simple rules engine can achieve.

In one variation, the server deploys the generative AI model on a dedicated inference server equipped with multiple graphics processing units and uses a model-serving framework to manage queues of requests. The server batches multiple prompt sentences and performs batched inference, thereby improving throughput and reducing per-request overhead. In another variation, the server uses a smaller distilled model for quick, low-latency itineraries and a larger model for high-detail itineraries, dynamically selecting the model size based on the complexity of the request and the user's latency tolerance.

In another embodiment, the server uses an additional ranking or scoring module that evaluates candidate itineraries generated by multiple runs of the generative AI model. The server computes scores based on criteria such as total travel time, diversity of activities, or user-specified constraints. The server then selects the highest-scoring itinerary and stores only that plan in the hierarchical structured data format, which reduces storage requirements and improves the quality of displayed itineraries.

In yet another embodiment, the server compresses the structured representation prior to transmission by applying a domain-specific encoding scheme that replaces repeated activity types or locations with short codes and reconstructs them on the terminal. This compression reduces communication bandwidth without sacrificing semantic fidelity and further demonstrates a technical improvement over naive text-based transmission.

Across these embodiments, the server uses specific data structures, normalization procedures, prompt construction algorithms, and control of generative model parameters to achieve faster processing, reduced parsing errors, improved storage efficiency, and lower communication overhead. These improvements arise from technical interactions between the structured data pipeline, the prompt generation functional unit, the generative AI model, and the terminal-side rendering process, and are not merely automation of human planning tasks.

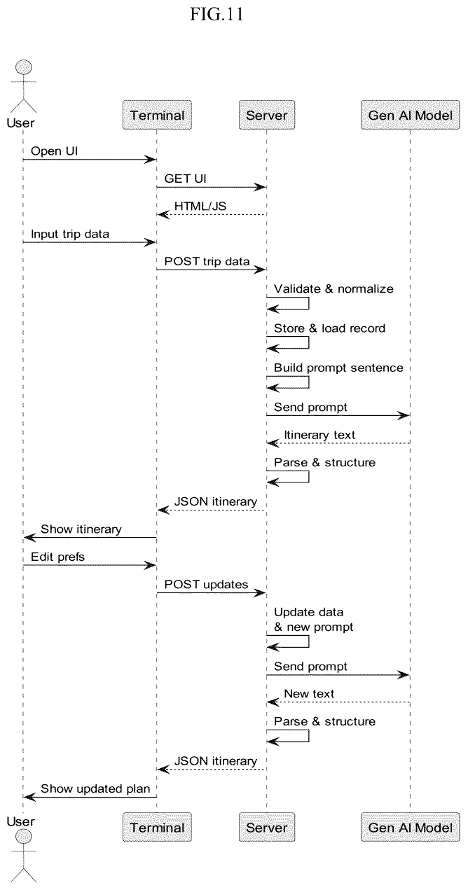

The following describes the processing flow using FIG. 11.

### Step 1

The terminal displays an input screen for travel conditions.

The terminal receives an HTML document, style information, and script information from the server and renders a screen-based input/output environment on a display. The terminal creates visual components such as text fields for a travel start date and travel end date, numeric fields for a number of participants, and list boxes for a departure location, an arrival location, and a travel mode.

Input: markup and script resources from the server.

Output: a rendered user interface on the display.

The terminal converts the received resources into a document object model and executes embedded script instructions to initialize default values and event handlers, thereby preparing the screen for user input.

### Step 2

The user inputs travel condition information.

The user operates an input device of the terminal, such as a keyboard or a touch panel, to enter specific values into the displayed fields. The user inputs, for example, a start date “2023 Dec. 1,” an end date “2023 Dec. 5,” a number of participants “4,” a departure location “Tokyo,” an arrival location “Kyoto,” and selects “Shinkansen” as the travel mode.

Input: the rendered user interface on the terminal.

Output: raw travel condition values stored in the terminal's memory.

The terminal captures the keystrokes and selections via event listeners, updates internal variables corresponding to each field, and maintains a current state object that holds the user-entered values.

### Step 3

The terminal validates and packages the travel condition information.

The terminal performs client-side checks, such as verifying that the start date precedes or equals the end date, that the number of participants is a positive integer, and that required fields are not empty. The terminal displays error messages if a check fails and prevents submission until the errors are corrected.

Input: raw travel condition values in the terminal's memory.

Output: a structured request payload containing validated travel condition information.

The terminal converts the validated values into a structured representation, for example a key-value map, and serializes this representation into a message format such as JSON or form-encoded text in preparation for network transmission.

### Step 4

The terminal sends the travel condition information to the server.

The terminal transmits an HTTP request over a network to an application endpoint on the server. The terminal writes the serialized travel condition information into the body of the request and adds protocol headers identifying the content type and destination path.

Input: the structured request payload prepared by the terminal.

Output: a network message delivered to the server.

The terminal uses a communication interface to encapsulate the payload in transport-layer packets and sends those packets to the server's network address.

### Step 5

The server receives and parses the travel condition information.

The server accepts the incoming HTTP request through a network interface and passes it to an application framework. The server extracts the body of the request and decodes the serialized format to reconstruct a structured representation containing fields such as start date, end date, number of participants, departure location, arrival location, and travel mode.

Input: the network message containing the travel condition information.

Output: a structured in-memory object holding the travel condition information.

The server performs parsing operations, such as splitting strings, converting text representations of numbers to numeric types, and mapping field names to internal variable names, thereby making the data available for further processing.

### Step 6

The server validates and normalizes the travel condition information.

The server checks that the date strings conform to a predefined format and converts them into internal date objects. The server verifies that the number of participants lies within a permissible range and that the departure and arrival locations correspond to known locations in a reference table. The server rejects or corrects inconsistent values according to predetermined rules.

Input: the structured in-memory object holding raw travel condition information.

Output: a normalized record with canonical values for dates, locations, and travel mode.

The server performs data transformations, such as converting free-form location names into canonical identifiers stored in a location master table and mapping a textual travel mode to a normalized enumeration code, thereby creating a consistent representation suitable for storage and further computation.

### Step 7

The server stores the normalized travel condition information in a database.

The server connects to a relational database system and constructs an insertion command containing the normalized values and a newly generated trip identifier. The server writes the normalized record into a table dedicated to travel requests.

Input: the normalized record produced by the validation and normalization step.

Output: a persistent database row identified by a trip identifier.

The server sends the insertion command to the database engine, which allocates storage for the row and updates indexes, enabling subsequent retrieval based on the trip identifier or other key attributes.

### Step 8

The server retrieves the normalized data and constructs a structured data set.

The server queries the database for the stored record using the trip identifier or other criteria. The server receives the row from the database and loads it into memory. The server computes a number of travel days by subtracting the start date from the end date according to a date arithmetic rule and may derive additional attributes such as a distance category between locations.

Input: the persistent database row for the trip.

Output: an enriched structured data set containing normalized fields and derived attributes.

The server aggregates the original normalized values and the derived values into a composite data object, which groups related attributes for use in prompt sentence construction.

### Step 9

The server generates a prompt sentence for the generative AI model.

The server selects, from a set of stored sentence templates, a template appropriate for the travel duration or travel mode. The server inserts elements of the structured data set, such as the number of travel days, the number of participants, normalized departure and arrival locations, and the travel mode, into placeholders within the chosen template.

Input: the enriched structured data set and a selected sentence template.

Output: a prompt sentence in natural language configured for the generative AI model.

The server performs string formatting operations that replace placeholder markers with actual values and produce a complete text instruction, such as:

“Please create a detailed 5-day travel plan for 4 people traveling from Tokyo to Kyoto by Shinkansen from 2023 Dec. 1 to 2023 Dec. 5. Include daily schedules with morning, afternoon, and evening activities, recommended sightseeing spots, meal suggestions, and hotel options near major attractions.”

### Step 10

The server sends the prompt sentence to the generative AI model and performs model inference.

The server tokenizes the prompt sentence into units compatible with the generative AI model's vocabulary and embeds each token into a vector space. The server transmits the resulting token sequence to a model processing unit either locally or over a network.

Input: the prompt sentence generated by the server.

Output: a token sequence representing the beginning of a travel itinerary plan text.

The generative AI model, implemented as a neural network, processes the embeddings through attention and feed-forward layers to compute probability distributions over subsequent tokens. The server configures parameters such as maximum output length and sampling strategy and causes the model processing unit to repeatedly generate tokens until a termination condition is met, thereby producing a complete travel itinerary plan text in the model's output buffer.

### Step 11

The server receives and stores the generated travel itinerary plan text.

The server collects the tokens produced by the generative AI model and converts them back into a textual sequence. The server assembles the tokens into sentences and paragraphs that describe daily itineraries, activities, transportation, and lodging suggestions.

Input: the sequence of generated tokens from the model processing unit.

Output: a travel itinerary plan text stored in the server's memory.

The server may log the text along with metadata such as the prompt sentence and model parameters used, thus enabling auditing and further analysis.

### Step 12

The server analyzes and segments the travel itinerary plan text.

The server scans the text for predefined markers or headings, such as “Day 1,” “Day 2,” and “Day 3,” and splits the text at those markers to isolate the description for each day. The server searches for time-related keywords, such as “morning,” “afternoon,” and “evening,” within each day's segment and further segments each day into time slots.

Input: the travel itinerary plan text stored in memory.

Output: segmented text portions associated with specific days and time slots.

The server applies pattern matching and text classification rules to identify sentences describing activities, travel between locations, and lodging. The server labels each sentence with one or more categories, generating an intermediate representation that associates text fragments with structural roles.

### Step 13

The server converts the segmented text into a hierarchical structured data format.

The server creates a hierarchical data object that includes, at a top level, a list of days, and within each day, a list of time slots, and within each time slot, a list of labeled activities. The server attaches additional attributes, such as locations and approximate times, to activity entries based on information extracted from the text.

Input: segmented and labeled text portions from the analysis step.

Output: a hierarchical structured data object representing the travel itinerary plan.

The server constructs nested structures such as arrays or maps, assigning keys for day numbers, time period identifiers, and activity indices, thereby producing a machine-readable representation that reflects the logical organization of the itinerary.

### Step 14

The server prepares the structured data for transmission to the terminal.

The server converts the hierarchical structured data object into a compact transmission format by serializing it into a structured message and optionally replacing repeated strings, such as location names, with short codes. The server ensures that the serialization preserves all relationships between days, time slots, and activities.

Input: the hierarchical structured data object.

Output: a serialized data representation suitable for network transmission.

The server determines which parts of the structure are necessary for initial display and may omit or compress less critical details to reduce payload size and transmission time.

### Step 15

The server transmits the structured itinerary data to the terminal.

The server creates an HTTP response containing the serialized itinerary data as the body and sets appropriate headers to indicate the content type. The server sends the response over the network interface to the terminal's address.

Input: the serialized data representation prepared by the server.

Output: a network response message containing the itinerary data delivered to the terminal.

The server writes the serialized bytes into transport-layer buffers and initiates transmission, allowing the terminal to receive the itinerary plan with the intended structure.

### Step 16

The terminal receives and parses the structured itinerary data.

The terminal accepts the network response and extracts the serialized body. The terminal deserializes the body back into an in-memory structured representation corresponding to the days, time slots, and activities of the itinerary.

Input: the network response message from the server.

Output: an in-memory representation of the travel itinerary plan on the terminal.

The terminal checks for integrity and error conditions and, if the data is valid, stores the structured object for subsequent rendering.

### Step 17

The terminal renders the travel itinerary plan to the user.

The terminal iterates over the structured representation and creates display elements for each day, such as headings and containers. The terminal creates nested elements for time slots and activities and inserts textual descriptions into these elements.

Input: the in-memory structured representation of the itinerary.

Output: a visually presented travel itinerary plan on the terminal's display.

The terminal applies layout rules and style information to arrange the elements on the screen, and updates the screen-based input/output environment so that the user can view and scroll through the itinerary.

### Step 18

The user reviews the itinerary and provides correction input.

The user examines the displayed itinerary and decides, for example, that the number of activities per day is too high or that a certain type of attraction should be emphasized. The user interacts with controls on the terminal, such as check boxes and buttons, to specify preferences or constraints, such as “limit to 3 activities per day” or “prioritize historical sites.”

Input: the visually presented itinerary and interface controls.

Output: updated or additional travel condition information captured by the terminal.

The terminal records these corrections in an internal state object and prepares them for transmission as refined travel condition information.

### Step 19

The terminal sends the correction input to the server.

The terminal packages the corrections, including updated constraints and preferences, into a structured payload and sends a new request to the server.

Input: updated internal state containing correction input.

Output: a network message containing refined travel condition information.

The terminal uses the same or a related communication endpoint as in the initial request, thereby maintaining a consistent protocol for iterative refinement.

### Step 20

The server updates the structured data and regenerates the prompt sentence.

The server receives the refined travel condition information, updates the corresponding database record, and modifies the structured data set by inserting the new constraints, such as maximum activities per day or preference weights for attraction types. The server selects a sentence template that includes constraint expressions and fills placeholders with both the original conditions and the new constraints.

Input: refined travel condition information and the existing structured data set.

Output: an updated prompt sentence reflecting the corrections and constraints.

The server constructs, for example, a prompt sentence such as:

“Please regenerate the 5-day travel plan for 4 people traveling from Tokyo to Kyoto by Shinkansen from 2023 Dec. 1 to 2023 Dec. 5, limiting the number of activities to 3 per day and prioritizing historical sites over shopping, while preserving the structure organized by ‘Day 1’, ‘Day 2’, etc., with morning, afternoon, and evening time slots.”

The server then repeats the inference, analysis, structuring, and transmission steps, using the updated prompt sentence to produce a revised itinerary that better matches the user's constraints.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional travel support systems generally separate travel planning from meal arrangement, and typically provide only static links or simple search interfaces to food delivery services. In such systems, a server often retrieves predefined travel plan templates from a database and displays them to a user's terminal without deeply integrating dynamic food and beverage delivery options into the travel schedule. As a result, the server is not configured to adaptively generate meal delivery options that reflect the user's travel dates, number of participants, transportation methods, and day-by-day itinerary constraints, and thus cannot effectively coordinate delivery times, locations, and restaurant choices with the actual travel context.

Furthermore, in many existing architectures, the server performs only straightforward database retrieval and rule-based filtering, and does not leverage a generative AI model via a prompt sentence that is automatically constructed from structured travel data. Therefore, the server is not capable of automatically generating context-aware, itinerary-aligned delivery options at scale. This leads to several technical problems: increased user interaction load for manually searching and coordinating food delivery services, redundant network traffic due to multiple fragmented service calls, and underutilization of server-side computation for synthesizing heterogeneous information such as travel plans, delivery constraints, and restaurant attributes.

Additionally, existing systems typically handle output from AI services, if used at all, as unstructured free text that must be manually interpreted by users. This unstructured handling prevents the server from programmatically transforming AI-generated content into machine-readable, structured delivery option data that can be efficiently grouped by date and meal category, cross-validated with internal or external data sources, and used to drive automated reservation and ordering flows. The lack of structured integration results in inefficient server-side workflows, difficulty in automatically invoking external delivery service application programming interfaces, and limited ability to maintain consistent state across travel planning, meal arrangement, and order management.

Accordingly, there is a need for a computer-implemented technique that improves server-side processing in travel support systems by: (i) automatically generating a prompt sentence for a generative AI model based on structured travel input data and selected travel plan details; (ii) transforming AI-generated response information into structured delivery option data; (iii) grouping and presenting the delivery options per date and meal category on a terminal; and (iv) automatically interacting with external delivery service providing apparatuses for reservation and ordering. Such a technique should reduce user burden, improve the efficiency and scalability of server-side computation, and enhance the reliability and consistency of end-to-end travel and meal arrangement processing.

The specific processing by the specific processing unit 290 of the data processing device 12 in Application Example 1 is realized by the following means.

The present invention provides a server comprising a processor and a communication interface configured to provide, to a terminal, a visual information input and output interface for receiving structured travel-related input data from a user, to parse and validate the structured input data, to retrieve travel plan information and food and beverage delivery option information from an information storage device, to generate a plurality of travel plan candidates and transmit the plurality of travel plan candidates in a structured data format to the terminal, to generate a prompt sentence for a generative information processing model based on a selected travel plan candidate and the structured input data, to transmit a processing request including the prompt sentence to the generative information processing model, to receive response information from the generative information processing model, to generate structured delivery option data representing a plurality of food and beverage delivery options by analyzing the response information, to cause the food and beverage delivery options grouped by date unit and meal category unit to be displayed on the terminal and to accept selection of at least one food and beverage delivery option by the user, and to transmit delivery arrangement request data including reservation information and order information to an external delivery service providing apparatus based on the selected food and beverage delivery option and to receive and store arrangement completion information. This enables an improvement in computer functionality by allowing the server to automatically synthesize structured travel data and generative AI output into machine-readable delivery options, to reduce user interaction steps, to streamline server-side coordination with external delivery services, and to provide an integrated, itinerary-aware travel and meal arrangement process that operates more efficiently and reliably than conventional rule-based or manually coordinated systems.

The term “system” refers to an arrangement of hardware and software components including at least a processor, a communication interface, and one or more storage devices that cooperate to perform the claimed processing operations.

The term “processor” refers to one or more hardware processing units, such as a central processing unit or a processing core, capable of executing instructions to implement the functions described in the claims.

The term “communication interface” refers to hardware and associated control logic configured to enable data exchange between the system and external devices or networks, including wired or wireless communication units.

The term “terminal” refers to an information processing apparatus, such as a portable communication device or a general-purpose computing device, that includes a display, an input interface, and a communication function, and that is used by a user to interact with the system.

The term “visual information input and output interface” refers to a graphical user interface displayed on the terminal that enables a user to input data and receive output information through visual elements such as text fields, buttons, icons, and lists.

The term “user” refers to a person or entity that operates the terminal to input travel-related information, review travel plan candidates, select food and beverage delivery options, and confirm reservations or orders.

The term “schedule information” refers to data that specifies temporal aspects of travel, including at least a travel start date and a travel end date, and optionally time-of-day information for specific activities.

The term “participant number information” refers to data indicating the number of individuals for whom a travel plan and food and beverage delivery options are to be arranged.

The term “transportation method information” refers to data that indicates one or more types of transportation to be used during the travel, such as rail, road, air, or water-based transport.

The term “structured input data” refers to travel-related information organized in a predefined format, such as a record, table, or serialized object, that associates schedule information, participant number information, and transportation method information with defined data fields.

The term “server” refers to one or more computing devices, separate from the terminal, that execute server-side processes including data validation, database access, generative model interaction, and external service coordination.

The term “communication line” refers to a logical or physical communication path, implemented over wired or wireless networks, that enables data transfer between the terminal, the server, external services, and other components.

The term “information storage device” refers to one or more non-transitory storage media, such as a database system or file storage system, that store travel plan information, food and beverage delivery option information, and related metadata.

The term “travel plan information” refers to data describing one or more candidate travel plans, including at least destination information, schedule ranges, capacity constraints, and activity or accommodation information.

The term “food and beverage delivery option information” refers to data representing potential food and beverage delivery services, including at least information about providers, items, price ranges, and delivery constraints.

The term “search process” refers to a computational procedure in which the processor issues queries to the information storage device to obtain records that satisfy conditions derived from the structured input data.

The term “travel plan candidate” refers to a proposed travel plan instance derived from travel plan information that is compatible with the user's schedule information, participant number information, and transportation method information.

The term “structured data format” refers to a representation of information using a defined schema, such as a hierarchical or tabular structure, that associates specific fields with values in a machine-readable manner.

The term “travel plan detail information” refers to data describing elements of a selected travel plan candidate in greater granularity, including at least per-day schedules, locations, and activity timing.

The term “generative information processing model” refers to a machine-learned model, such as a generative AI model, configured to receive a prompt sentence and to generate output information in natural language or structured form based on the prompt sentence.

The term “prompt sentence” refers to a natural language or semi-structured instruction sequence provided to the generative information processing model to specify an information generation task, including constraints and desired output format.

The term “processing request” refers to a message transmitted to the generative information processing model that includes at least the prompt sentence and that instructs the model to generate output information.

The term “response information” refers to data returned from the generative information processing model in response to the processing request, including generated text, lists, or structured records describing food and beverage delivery options.

The term “structured delivery option data” refers to machine-readable data derived from the response information, organized according to a defined schema, and representing one or more food and beverage delivery options with associated attributes.

The term “food and beverage delivery option” refers to a combination of attributes that define a proposed delivery arrangement, including at least a provider, one or more items, an estimated price, and a delivery time or time window.

The term “date unit basis” refers to grouping or organizing information such that data elements are associated with specific calendar days within the travel period.

The term “meal category unit basis” refers to grouping or organizing information according to types of meals, including categories such as breakfast, lunch, and dinner, and optionally additional subcategories.

The term “selection operation” refers to an input action performed by the user via the terminal, such as tapping, clicking, or otherwise activating a user interface element, to indicate a choice of a travel plan candidate or a food and beverage delivery option.

The term “delivery arrangement request data” refers to data transmitted to an external delivery service providing apparatus that specifies at least a selected provider, ordered items, quantities, delivery location, and desired delivery time information.

The term “reservation information” refers to data specifying a booking or reservation context for a delivery, including at least an identifier, a scheduled date and time, and relevant contact or location information.

The term “order information” refers to data describing the content of an order, including selected items, quantities, and associated pricing or payment-related parameters.

The term “external delivery service providing apparatus” refers to a computer system operated by a delivery service provider that receives delivery arrangement request data, processes reservations and orders, and returns arrangement completion information.

The term “arrangement completion information” refers to data received from the external delivery service providing apparatus indicating the status of a delivery request, including at least an order identifier, confirmation status, and an expected delivery time.

In one embodiment, a server provides a travel support system that cooperates with a terminal operated by a user. The server includes at least one processor, a memory storing executable instructions and data structures, a network interface, and a database system. The terminal includes a display, an input device such as a touchscreen or keyboard, and a communication module. The server executes a program implemented, for example, in a high-level programming language such as a general-purpose interpreted language on an operating system running on a general-purpose computing platform. The database can be implemented as a relational database management system executing on a storage subsystem such as a magnetic disk or a solid-state drive. The generative AI model can be provided as a neural network hosted on an external computation platform that exposes an application programming interface accessible via a communication network.

The terminal presents a visual information input and output interface configured by the server. The terminal displays input fields for schedule information, participant number information, and transportation method information. The terminal uses a browser runtime or native user interface framework to render graphical components such as text boxes, list selectors, and buttons. The terminal performs client-side validation of basic formats, converts the user's input into structured input data, such as an object with fields for travel start date, travel end date, number of participants, and transportation type, and transmits the structured input data to the server via a secure communication protocol.

The user operates the terminal to input travel-related data. The user specifies, for example, a destination city, a start date and an end date, a number of participants, and a preferred transportation method such as rail or automobile. The user confirms the input via an interface element on the terminal. The user then receives, on the terminal display, travel plan candidates and later food and beverage delivery options that are computed and transmitted by the server.

The server receives the structured input data through the network interface and stores the structured input data in the memory. The server validates the structured input data by checking, for example, that the travel end date is not earlier than the travel start date, that the number of participants is positive and within system limits, and that the transportation method is among predefined types. The server converts the structured input data into a normalized internal data structure that maps to relational tables or similar data structures in the database.

The server accesses an information storage device that stores travel plan information and food and beverage delivery option information. The server employs a query generation module that constructs database queries from the structured input data. The server issues such queries to retrieve travel plan information whose attributes, such as destination, available date range, capacity, and transportation compatibility, match conditions derived from the structured input data. The server receives a set of travel plan records from the database and transforms them into candidate travel plan objects with associated metadata such as descriptive text, daily itinerary segments, estimated costs, and identifiers.

The server converts the candidate travel plan objects into a structured data format suitable for transmission, for example, a hierarchical representation with fields for plan identifier, title, summary, and day-by-day outline. The server sends this structured representation to the terminal. The terminal decodes the received data and visually presents the plurality of travel plan candidates. The user selects one travel plan candidate on the terminal by activating a user interface control associated with the selected candidate.

The server receives information identifying the selected travel plan candidate. The server retrieves travel plan detail information from the database, including, for example, a sequence of daily segments with attributes for location, time windows, and transportation between locations. The server optionally retrieves additional context data from external information providers, such as weather prediction data and local event data, and merges such context data into the travel plan detail information. The server organizes this information into a structured representation indexed by date and time segments so that subsequent computation can align food and beverage delivery times with available time windows in the travel plan.

The server prepares a prompt sentence for a generative AI model. The server generates the prompt sentence by combining the travel plan detail information with the original structured input data. The server composes a natural language instruction that specifies the task, constraints, and desired output format. The server includes in the prompt sentence: (i) destination, (ii) number of days, (iii) number of participants, (iv) approximate locations such as station areas or accommodation areas for each day, (v) available time windows for meals derived from the itinerary, and (vi) any constraints such as budget per meal or preferences. For example, the server can generate a prompt sentence such as: “I am planning a 3-day trip to a major city for 4 people who will mainly travel by train. The group stays near a central station. For each day, suggest breakfast and dinner food delivery options using food delivery services. For each option, provide a restaurant name, type of cuisine, approximate price per person, and a recommended delivery time that fits the sightseeing schedule. Group the results by day and meal (breakfast or dinner), and present them in a structured list.”

In another example, the server can generate a prompt sentence such as:

“For a family of 5 visiting a metropolitan area for 2 days by train, generate food delivery recommendations that are suitable for children and cost-effective. Include restaurant names, example menu items, approximate total cost for 5 people, and recommended delivery time windows near a main station for each day's dinner, grouped by day.”

The server constructs the prompt sentence according to a predefined template that embeds data elements from the structured input data and travel plan detail information into natural language slots. The server may also specify in the prompt sentence that the output should use a consistent pseudo-structured listing format with markers or delimiters that the server can reliably parse. This template-based construction of prompt sentences improves repeatability and parsing accuracy and reduces ambiguity compared to manual or ad-hoc prompt generation.

The server transmits a processing request including the prompt sentence to the generative AI model via the network interface. In one embodiment, the generative AI model is a parameterized neural network such as a transformer-based language model that has been pre-trained on large text corpora and optionally fine-tuned for travel-and food-related text. The generative AI model may include multiple self-attention layers, feedforward layers, and normalization layers configured with millions or billions of parameters. The model receives the prompt sentence tokenized into numeric vectors, applies attention mechanisms to compute contextual representations of tokens, and generates an output sequence of tokens representing text-based recommendations.

The server receives response information from the generative AI model. The response information includes descriptive content specifying, for example, restaurant names, cuisine types, approximate prices, and time windows for recommended deliveries. To avoid reliance on free-form text, the server constrains the generative AI model through the prompt sentence to produce output with explicit list structures, markers for day and meal, and attributes such as “restaurant:”, “cuisine:”, “price_per_person:”, and “time_window:”. Because the generative AI model is guided by such structured markers, the server can apply deterministic parsing rules to convert the response information into structured delivery option data.

The server analyzes the response information by scanning for delimiters and markers and mapping them into data fields. For each recommendation, the server constructs a data object that includes attributes for provider name, meal category, date index, recommended delivery time window, estimated price, and notes. The server thereby generates structured delivery option data representing a plurality of food and beverage delivery options. The server stores this structured delivery option data in the memory and, optionally, in the database for subsequent retrieval.

The server enriches the structured delivery option data by cross-checking store information and item information included in the response information against data obtained from external or internal information sources. The server may query an external food delivery platform's application programming interface or a local restaurant registry to retrieve identifiers, ratings, menus, and live availability data. The server compares names and location hints, and if a match is found within a similarity threshold, the server associates provider identification information, price information, delivery time slot constraints, and evaluation information with the corresponding delivery option. This cross-validation and enrichment phase converts generative AI output from a purely textual form into actionable, machine-resolvable entities that can be used to automatically construct order requests.

The server groups the structured delivery option data by date unit and meal category unit. The server organizes the options into collections keyed by travel day index and meal category, such as breakfast or dinner. This grouping enables the server to efficiently generate views for the terminal and to quickly apply filtering and selection operations. Because the data is structured and indexed, the server can, for example, compute aggregated cost estimates per day or detect overlapping delivery windows that may conflict with travel events.

The terminal receives the structured delivery option data from the server. The terminal visually presents, for each day and meal category, a list of food and beverage delivery options showing attributes such as restaurant name, cuisine type, estimated price per person, and recommended delivery time window. The user can scroll through the options and select one or more options per day and meal by manipulating user interface elements on the terminal.

The server receives data representing the user's selections. The server maps each selected delivery option to a corresponding provider and one or more menu items. If the generative AI model has suggested example menu compositions, the server uses them as a basis and may adjust item quantities based on the participant number information. The server constructs delivery arrangement request data for each selected option. The delivery arrangement request data includes provider identification information, item information, quantities, delivery address derived from the travel plan (such as the lodging address), the requested delivery time window, and contact information. The server transmits the delivery arrangement request data to an external delivery service providing apparatus via a defined application programming interface.

The external delivery service providing apparatus processes the request and returns arrangement completion information, including, for example, an order identifier, a confirmation status flag, and a predicted delivery time. The server receives the arrangement completion information, stores it along with the travel plan data and structured delivery option data, and transmits confirmation information to the terminal. The terminal displays a confirmation screen that allows the user to verify order identifiers, delivery times, and provider names.

The server thereby improves computer technology in several concrete ways. The server reduces network traffic and computation overhead by aggregating travel context and delivery requirements into a single, well-structured prompt sentence, rather than requiring multiple sequential queries to various services. The server leverages the generative AI model not as a simple replacement for human judgment but as a context-aware generator of preliminary options that are subsequently normalized, structured, and validated by algorithmic modules. This architecture allows the server to offload pattern synthesis to the generative model while retaining deterministic control over data structure, constraints, and validation. As a result, the server can automatically generate a large number of itinerary-aligned delivery options without increasing user interaction burden or manual curation.

The server improves accuracy and consistency compared to manual or rule-only methods. Because the server automatically aligns delivery time windows with time segments in the travel plan, the server reduces errors where suggested meal times conflict with travel events. The server's structure-enforcing prompt sentence and parsing logic reduce ambiguity in interpreting generative AI output, leading to fewer parsing failures and more reliable data ingestion. The system architecture thus enhances data management by maintaining coherent relations between travel plans, delivery options, and order records in the database, which in turn supports efficient queries and updates.

The server also improves processing efficiency by operating on structured input data and structured delivery option data rather than on unstructured text. The server's use of indexed, normalized data structures enables efficient search, sorting, grouping, and conflict detection. Because the grouping by date and meal category is performed server-side, the amount of display logic and computation required on the terminal is reduced, leading to lower client-side resource consumption and lower communication load.

The generative AI model itself can be trained using supervised fine-tuning on domain-specific data. A training dataset can consist of pairs of prompt sentences and desired outputs that contain structured lists of delivery options aligned with itineraries. The generative AI model can be trained with a loss function such as cross-entropy over token sequences, with regularization techniques such as dropout applied in the transformer layers. The model's parameters can be updated using gradient-based optimization algorithms. Data augmentation techniques, such as randomizing meal budgets, varying transportation types, and altering itinerary structures, can improve the model's generalization ability. By designing the prompt sentence structure and the desired output pattern specifically for travel and delivery coordination, the server's architecture tailors the generative AI model's behavior to a technical problem: generating machine-parseable, itinerary-aligned options under defined constraints.

In an alternative embodiment, the server can implement additional rule-based filters applied after receiving the generative AI output, such as enforcing maximum walking distance between delivery providers and lodging, or enforcing dietary restrictions. These filters are implemented as explicit computational rules that operate on structured attributes. Such post-processing further distinguishes the system from simple automation of human choices by embedding non-obvious, machine-implemented constraints that operate over complex structured data.

In another embodiment, the terminal may be a specialized in-vehicle device or a kiosk located at a lodging facility. In such embodiments, the server can further adapt the structured delivery option data to device-specific capabilities, for example by limiting the number of options displayed or by pre-computing offline caches to reduce latency and communication load in bandwidth-constrained environments.

In another embodiment, the server can dynamically adjust the prompt sentence based on feedback or historical data. If the server detects, based on prior sessions, that the generative AI model tends to produce outputs that are difficult to parse, the server can modify the prompt sentence to add more explicit output formatting instructions, thereby reducing parsing errors and improving the quality of structured delivery option data. This adaptive prompting mechanism produces a technical improvement in the robustness of interfacing between the server and the generative AI model.

By combining structured travel data, template-based prompt generation, generative AI output constrained into a parseable format, and deterministic post-processing with external data sources, the server implements a specific and non-conventional arrangement of components that improves the functioning of the computer system itself. The system's data structures, processing pipeline, and control logic not only support a particular business scenario but also yield measurable technical effects such as reduced communication load, improved processing speed for itinerary-aligned suggestions, increased accuracy in delivery timing alignment, and a lower error rate in AI output parsing.

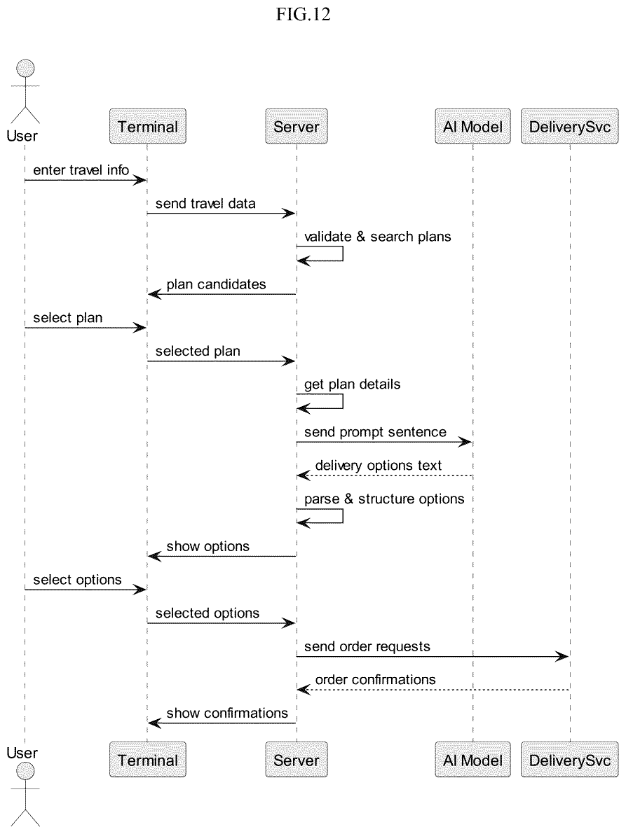

The following describes the processing flow using FIG. 12.

### Step 1

User operates the terminal to input travel schedule information, participant number information, and transportation method information via a visual interface.

Input: User-provided values such as destination, travel start date, travel end date, number of participants, and transportation type.

Output: Raw input values encoded in input fields on the terminal.

Terminal validates basic formats (for example, date formats and numeric ranges) using client-side logic and converts the raw input values into structured input data with predefined fields. Terminal performs data processing by mapping each visual input element to a corresponding field name and normalizing values (for example, converting date strings to a standardized format) and then prepares the structured input data for transmission.

### Step 2

Terminal sends the structured input data to the server via a communication network.

Input: Structured input data containing normalized schedule information, participant number information, and transportation method information.

Output: A network request message addressed to the server, containing the structured input data.

Terminal performs data serialization and encapsulates the structured input data into a request body, attaches necessary headers, and initiates a secure network transmission. This processing converts in-memory data structures on the terminal into a byte stream suitable for network transport.

### Step 3

Server receives the structured input data from the terminal and performs validation and normalization.

Input: Network request message containing structured input data.

Output: Validated and normalized travel parameter data stored in server memory.

Server parses the request body, reconstructs the structured input data as an internal data object, and checks each field for correctness and completeness. Server executes data processing by verifying logical constraints (for example, start date not after end date, participant count above zero) and by converting external representations (for example, strings) into internal formats (for example, timestamps and integer values). Server discards or corrects invalid fields according to predefined rules and stores the resulting normalized travel parameters in memory for further computation.

### Step 4

Server retrieves travel plan information from an information storage device based on the normalized travel parameter data.

Input: Normalized travel parameter data including schedule, participant number, and transportation method.

Output: A set of travel plan records that satisfy the input conditions.

Server converts the normalized travel parameter data into query conditions and formulates access commands to the information storage device. Server performs data processing by executing filtering operations in the storage layer, matching fields such as destination, date range, capacity limits, and transportation compatibility against stored travel plan information. Server receives a subset of records as query results and loads those records into in-memory structures for subsequent processing.

### Step 5

Server generates travel plan candidates from the retrieved travel plan records and sends them to the terminal.

Input: Travel plan records retrieved from the information storage device.

Output: Structured travel plan candidate data transmitted to the terminal.

Server performs data processing by transforming each travel plan record into a candidate object with selected attributes (such as title, summary description, and daily itinerary outline). Server may compute derived values, such as total estimated cost or duration, by aggregating fields in each record. Server then serializes the collection of travel plan candidates into a structured format for network transmission and sends this data to the terminal.

### Step 6

Terminal receives the travel plan candidates and presents them visually to the user for selection.

Input: Structured travel plan candidate data from the server.

Output: User-readable visual representation of travel plan candidates and a selected travel plan identifier.

Terminal parses the received structured data into internal objects and renders user interface components such as cards or lists that display the attributes of each travel plan candidate. Terminal performs data processing by mapping each candidate's fields to visual elements and assigning identifiers to selection controls. User then selects one travel plan candidate, and the terminal captures this selection and extracts the corresponding identifier as an output for subsequent transmission.

### Step 7

Terminal sends the selected travel plan identifier to the server.

Input: Selected travel plan identifier generated from the user's selection.

Output: Network request containing the selected travel plan identifier.

Terminal performs data processing by encapsulating the selected identifier into a structured message, adding any necessary context (such as a session identifier), and transmitting this message to the server as a request for detailed processing.

### Step 8

Server retrieves travel plan detail information and contextual data based on the selected travel plan identifier.

Input: Network request containing the selected travel plan identifier.

Output: A detailed travel plan representation combining itinerary details and contextual information.

Server queries the information storage device to obtain detailed data for the selected plan, including per-day itineraries, locations, and time windows. Server may also call external data providers to obtain contextual information such as weather forecasts or local event data for the relevant dates and locations. Server performs data processing by merging the detailed travel plan records with the contextual data, aligning them by date and location, and generating an augmented itinerary structure indexed by day and time segment. This augmented structure serves as an input for generating a prompt sentence.

### Step 9

Server generates a prompt sentence for a generative AI model based on the detailed travel plan information and the structured input data.

Input: Augmented itinerary structure and original normalized travel parameter data.

Output: A prompt sentence that instructs the generative AI model to generate food and beverage delivery options.

Server performs data processing by applying a template-based construction algorithm that inserts travel attributes (such as number of days, number of participants, and locations) and available time windows into predefined textual templates. For example, the server can produce a prompt sentence such as:

“I am planning a 3-day trip to a major city for 4 people who will mainly travel by train. The group stays near a central station. For each day, suggest breakfast and dinner food delivery options using food delivery services. For each option, provide a restaurant name, type of cuisine, approximate price per person, and a recommended delivery time that fits the sightseeing schedule. Group the results by day and meal (breakfast or dinner), and present them in a structured list.”

The server combines multiple data items into coherent natural language instructions, thereby transforming a structured data representation into a single, context-rich prompt sentence suitable for generative processing.

### Step 10

Server transmits the prompt sentence to the generative AI model and receives response information.

Input: Prompt sentence constructed from the detailed travel plan and travel parameters.

Output: Textual response information containing candidate food and beverage delivery options.

Server packages the prompt sentence into a request message according to the interface specification of the generative AI model and transmits the request via a communication channel. The generative AI model internally converts the prompt sentence into tokens, processes the tokens using a neural network to generate output tokens, and returns a response string. Server receives the response string and stores it as raw response information for further analysis.

### Step 11

Server parses the response information from the generative AI model and generates structured delivery option data.

Input: Textual response information containing recommended food and beverage delivery options.

Output: Structured delivery option data representing multiple options with explicit attributes.

Server performs data processing by scanning the response text for markers and patterns that were requested in the prompt sentence (for example, day labels, meal labels, and labels such as “restaurant:”, “cuisine:”, “price_per_person:”, and “time_window:”). Server applies parsing rules to segment the response into individual options and to extract attribute values for each option. Server then constructs structured data objects for each option and organizes those objects into a collection. The server assigns internal identifiers to each delivery option and indexes them by date and meal category to facilitate efficient access.

### Step 12

Server enriches and validates the structured delivery option data by cross-checking with internal and external information sources.

Input: Structured delivery option data derived from the generative AI model response and, optionally, provider and item information from external or internal data sources.

Output: Enriched structured delivery option data containing provider identification, price, delivery time slot, and evaluation information.

Server queries external or internal repositories for provider metadata, such as identifiers, location coordinates, and rating scores. Server performs data processing by computing similarity measures between names and locations in the delivery option data and the stored provider records. If the similarity is above a threshold, the server links the option to a specific provider record and aggregates associated attributes (such as base delivery fee, typical preparation time, or rating) into the structured delivery option data. The server thereby refines and validates the AI-generated suggestions using deterministic matching operations and attribute augmentation.

### Step 13

Server groups the enriched structured delivery option data by date and meal category and sends the grouped data to the terminal.

Input: Enriched structured delivery option data indexed by internal identifiers.

Output: Grouped delivery option data transmitted to the terminal for user selection.

Server performs data processing by partitioning the options based on the date index and meal category field and arranging them in ordered lists. Server may compute per-day aggregated costs or time-based summaries to attach as additional fields. The grouped data is serialized into a format suitable for network transfer and transmitted to the terminal.

### Step 14

Terminal receives the grouped delivery option data and visually displays the options to the user.

Input: Grouped delivery option data for each date and meal category.

Output: Visual listing of food and beverage delivery options and subsequent user selections.

Terminal parses the grouped data into internal objects and generates visual components such as day headers and meal category sections, under which the selectable options are presented. Terminal performs data processing by binding each option's attributes (restaurant name, cuisine type, price, time window) to visible elements like text labels and buttons. User then selects one or more options for each relevant date and meal category, and the terminal records these selections as a collection of selected option identifiers with associated scheduling information.

### Step 15

Terminal sends the user's selected food and beverage delivery options to the server.

Input: Identifiers and metadata of user-selected delivery options.

Output: Network request containing selection data for delivery arrangement processing.

Terminal coordinates the selected option identifiers and any additional user inputs (such as special notes) into a structured message. Terminal carries out data processing by organizing the selected options into an array or list and by attaching relevant travel context such as lodging address identifiers. The terminal then transmits this structured selection message to the server.

### Step 16

Server constructs delivery arrangement request data and communicates with an external delivery service providing apparatus.

Input: User-selected delivery option identifiers and enriched structured delivery option data.

Output: Delivery arrangement request data transmitted to the external delivery service and arrangement completion information received from the external service.

Server locates the full attribute set for each selected option using the identifiers and structured delivery option data. Server performs data processing by mapping each option to a concrete delivery request containing provider identification, menu items, quantities determined by the participant number information, delivery address, and requested delivery time window. The server composes request messages according to the external delivery service's interface protocol and transmits those messages. Server then receives arrangement completion information, parses it to obtain order identifiers and confirmation statuses, and stores these values in association with the corresponding travel plan and delivery options.

### Step 17

Server sends arrangement completion information to the terminal for user confirmation.

Input: Arrangement completion information received from the external delivery service.

Output: Confirmation data transmitted to the terminal and shown to the user.

Server performs data processing by summarizing each confirmed or pending order into a concise structure that includes at least the provider name, delivery time, and order identifier. Server serializes this summary as confirmation data and transmits it to the terminal. Terminal receives this data, renders a confirmation screen, and allows the user to review the final arrangement, thereby completing the integrated travel and food and beverage delivery coordination process.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented travel planning systems typically rely on static rule-based engines or simple keyword search over stored travel plan records. In such systems, a server generally receives a small set of user inputs, such as a destination and travel dates, performs a basic matching operation against a database, and returns a list of pre-defined plans. These systems suffer from several technical limitations.

First, the server usually treats user input as a flat parameter set and does not normalize or structure the input into machine-usable search condition data. As a result, the server performs inefficient database queries, often retrieving either too many or too few candidate plans, leading to increased processing load on the server and unnecessary data transfer to the user terminal.

Second, the integration of generative AI models into such systems is often naive. A conventional server typically forwards a user's free-form natural language request directly to a generative AI model, without incorporating structured travel plan candidate data or contextual attributes from a prior database search. This approach causes the generative AI model to regenerate information that is already available in structured form, wastes computational resources on the AI infrastructure, and produces responses that are inconsistent with available travel products stored in the database. In addition, conventional systems do not define a standardized, structured prompt-generation process that translates normalized user input and database-derived attributes into well-formed prompt data for the generative AI model.

Third, traditional systems generally return generative AI output as unstructured text. In such cases, the server sends a long, free-form itinerary description to the terminal, which makes it difficult for the terminal to parse and render the information in a fine-grained visual user interface, for example, on a per-day and per-time-zone basis. This lack of structured data representation complicates downstream processing, including incremental refinement, filtering, and reuse of partial plan segments, and increases the processing burden on the client side.

Fourth, existing systems rarely integrate external context information, such as weather data and event data, into the generative AI workflow in a systematic, machine-processable way. Even if weather information or event information is displayed, it is often fetched and overlaid on the client side as separate content, not incorporated into a structured travel plan data model generated and maintained on the server. This leads to duplicated processing, inconsistencies between textual descriptions and actual external conditions, and higher network load due to redundant API calls from multiple clients.

In view of the above, there is a need for a computer-implemented travel planning system that improves server-side processing by (i) normalizing user input into structured search conditions, (ii) efficiently querying and ranking database-resident travel plan candidates, (iii) generating, on the server, prompt data for a generative AI model that combines user prompt sentences with structured candidate attributes, and (iv) transforming the AI output into a structured, day-by-day data format enriched with weather and event annotations. Such improvements can reduce redundant computation, lower network traffic, and enable more efficient rendering and refinement of travel plans at the terminal, thereby improving the overall performance and scalability of the computer system.

The specific processing by the specific processing unit 290 of the data processing device 12 in Example 2 is realized by the following means.

The present invention provides a server comprising a processor and a memory storing instructions which, when executed by the processor, cause the server to provide, to a terminal, a visual user interface for receiving user information including at least travel schedule, stay location, number of travelers, budget, transportation method, and preference conditions; to receive, via a communication network, the user information from the terminal; to store the received user information in a storage device and normalize the user information to generate search condition data including at least a number of travel days, a cost range, and destination attributes; to query, on the basis of the search condition data, a database management device functioning as an information storage device for travel plan information, and to extract, from the database management device, a plurality of travel plan candidate data items that match the search condition data; to perform ranking processing for the plurality of extracted travel plan candidate data items based on a degree of match, to generate candidate list data including at least an identifier, summary information, required days, and cost information for each travel plan candidate, and to transmit the candidate list data, in a structured data format, to the terminal so that the candidate list data is visually displayed on the visual user interface; to generate, when a user selects at least one travel plan candidate from the candidate list data and transmits a natural language prompt sentence from the terminal together with a result of the selection, generation instruction information including attribute information relating to the selected travel plan candidate and the prompt sentence, and to create prompt data, by a prompt generation module, to be input to a generative AI model on the basis of the generation instruction information; to input the prompt data to the generative AI model, to cause the generative AI model to generate detailed travel plan data including at least day-by-day activity contents, time-zone-specific activity proposals, and facility usage proposals, and to acquire the detailed travel plan data from the generative AI model; and to perform a formatting process on the detailed travel plan data by associating and adding supplementary information based on weather information data and event information data acquired from an external information supply device, and converting the detailed travel plan data into detailed travel plan structured data that is structured on a per-day basis and is in a format transmittable to the terminal. This enables improved utilization of computing resources by performing server-side normalization and ranking of travel plan candidates, generation of structured prompt data that leverages both user prompt sentences and database-derived attributes for the generative AI model, and transformation of the generative AI output into a machine-readable, enriched itinerary representation, thereby reducing redundant processing at the terminal, decreasing network traffic, and enhancing the efficiency, consistency, and scalability of the computer-based travel planning workflow.

The term “processor” refers to a hardware or virtual processing unit capable of executing computer-readable instructions, including but not limited to a central processing unit, a graphics processing unit, or a combination thereof configured to perform the described operations of the server.

The term “terminal” refers to an information processing apparatus operated by a user, including but not limited to a mobile device, a tablet device, a desktop device, or a network-enabled display device, that provides a visual user interface and communicates with the server via a communication network.

The term “visual user interface” refers to a graphical or otherwise visually perceivable interface presented on a display device of the terminal, through which a user can input information and view information, including but not limited to screens, windows, dialog boxes, input fields, lists, and graphical controls.

The term “user information” refers to data input by a user through the visual user interface, including but not limited to a travel schedule, a stay location, a number of travelers, a budget, a transportation method, and preference conditions related to travel.

The term “preference conditions” refers to user-specified conditions that characterize desired attributes of a travel plan, including but not limited to preferred activity types, lodging types, dietary preferences, walking intensity, or cultural interests.

The term “storage device” refers to a hardware or virtual storage resource used to store data, including but not limited to a magnetic storage device, a solid-state storage device, a network-attached storage system, or a cloud-based storage service.

The term “normalize” refers to processing raw user information or other raw data to convert it into a standardized, structured form, including but not limited to converting date strings to date objects, computing a number of travel days, unifying currency units, and categorizing destinations into destination attributes.

The term “search condition data” refers to structured data derived from user information and used as input conditions for searching travel plan information, including but not limited to a number of travel days, a cost range, and destination attributes.

The term “cost range” refers to one or more values that represent an allowable budget interval for a travel plan, including but not limited to a minimum cost, a maximum cost, or a target cost value.

The term “destination attributes” refers to structured information that characterizes a travel destination, including but not limited to a geographic region, an urban or rural classification, activity categories available at the destination, and seasonal characteristics.

The term “database management device” refers to a computing resource that manages access to a structured data repository, including but not limited to a relational database management system, a key-value database system, or an object-oriented database system.

The term “information storage device for travel plan information” refers to a logical or physical data repository managed by a database management device and storing travel plan information, including but not limited to records of destinations, schedules, activities, accommodations, and associated costs.

The term “travel plan candidate data” refers to structured data records representing possible travel plans retrieved from the information storage device on the basis of search condition data, each record including at least a destination, a duration, and cost-related information.

The term “ranking processing” refers to computation performed to assign a relative order or score to travel plan candidate data, based on a degree of match to search condition data or other criteria, and to sort or filter the candidates according to the assigned order or score.

The term “degree of match” refers to a quantitative or qualitative measure of similarity or suitability between search condition data and travel plan candidate data, including but not limited to exact matches, partial matches, or weighted similarity scores for attributes such as destination, duration, and budget.

The term “candidate list data” refers to structured output data generated from ranked travel plan candidate data, including at least an identifier, summary information, required days, and cost information for each candidate that is to be transmitted to the terminal.

The term “identifier” refers to data that uniquely or distinctively identifies a travel plan candidate within the system, including but not limited to a numeric identifier, an alphanumeric code, or a globally unique identifier.

The term “summary information” refers to a concise description of a travel plan candidate, including but not limited to major activities, notable destinations, and overarching themes of the plan.

The term “required days” refers to a number of calendar days or equivalent units that represent the duration of a travel plan candidate.

The term “structured data format” refers to a representation of data organized according to a defined schema or structure, including but not limited to a hierarchical format, a table format, or a markup format, such as a format equivalent to a JavaScript Object Notation format or a similar machine-readable format.

The term “natural language prompt sentence” refers to a user-provided textual input expressed in a natural language and intended to request generation, modification, or refinement of a travel plan by a generative AI model.

The term “generation instruction information” refers to structured data that specifies instructions for generating or refining travel plan data, including but not limited to attribute information relating to a selected travel plan candidate and contents of a natural language prompt sentence.

The term “attribute information” refers to structured data describing properties of a selected travel plan candidate, including but not limited to a destination, duration, cost, activity categories, or accommodation type.

The term “prompt generation module” refers to a functional component implemented by software and/or hardware that creates prompt data for input to a generative AI model, based on generation instruction information.

The term “prompt data” refers to a structured representation of instructions and context provided to a generative AI model, including but not limited to system-level information, user-level information, and travel plan attributes derived from a database.

The term “generative AI model” refers to an artificial intelligence model configured to generate output data, including natural language text, based on provided input prompt data, and implemented using a machine learning or deep learning framework.

The term “detailed travel plan data” refers to travel plan information generated by a generative AI model, including at least day-by-day activity contents, time-zone-specific activity proposals, and facility usage proposals.

The term “day-by-day activity contents” refers to descriptions of travel activities assigned to specific calendar days within a travel period.

The term “time-zone-specific activity proposals” refers to activity descriptions assigned to sub-periods within a day, including but not limited to morning, afternoon, and night time zones.

The term “facility usage proposals” refers to recommended use of facilities associated with a travel plan, including but not limited to accommodations, restaurants, transportation facilities, and event venues.

The term “external information supply device” refers to a computing resource, external to the server, that provides supplementary information including but not limited to weather information data and event information data, via a communication network.

The term “weather information data” refers to data describing weather conditions relevant to a travel plan, including but not limited to forecasts, temperature, precipitation, and weather warnings.

The term “event information data” refers to data describing events relevant to a travel destination and travel period, including but not limited to performances, festivals, exhibitions, and local gatherings.

The term “supplementary information” refers to additional data that enhances or annotates detailed travel plan data, including but not limited to notes or fields derived from weather information data and event information data.

The term “detailed travel plan structured data” refers to a representation of detailed travel plan data that is organized according to a defined structure on a per-day basis, including fields for time-zone-specific activities, recommended facilities, and annotations.

The term “extended generation instruction information” refers to generation instruction information that has been augmented with analysis results derived from a prompt sentence, including at least one of a travel day change request, a cost adjustment request, an activity type change request, or a target-person attribute change request.

The term “travel day change request” refers to a user request to modify the length or distribution of days in a travel plan.

The term “cost adjustment request” refers to a user request to modify the budget level or cost distribution of a travel plan.

The term “activity type change request” refers to a user request to modify types or categories of activities in a travel plan, including but not limited to changing from indoor activities to outdoor activities, or from cultural activities to recreational activities.

The term “target-person attribute change request” refers to a user request to modify assumed attributes of travelers, including but not limited to age group, family composition, physical ability, or special needs.

The term “activity content field” refers to a data field within detailed travel plan structured data that stores information describing an activity for a particular time zone of a day.

The term “recommended facility field” refers to a data field within detailed travel plan structured data that stores information identifying or describing a facility recommended for use in connection with an activity, including but not limited to lodging, dining, or transportation facilities.

The term “weather-related annotation field” refers to a data field within detailed travel plan structured data that stores annotations derived from weather information data, including but not limited to advisories, recommendations, or warnings related to weather conditions.

The term “event-related annotation field” refers to a data field within detailed travel plan structured data that stores annotations derived from event information data, including but not limited to references to events, schedules, or venues relevant to the travel plan.

In one embodiment, a server cooperates with one or more terminals operated by a user to implement a travel plan generation system. The server includes at least one processor, a main memory, a non-volatile storage device, and a network interface. The server executes application software implemented, for example, using an application framework such as a web server framework and a database access library. The server is connected, via a communication network, to an information storage device implemented as a database management system and to one or more external information supply devices providing weather information data and event information data. The terminal includes a processor, a memory, a display device, an input device, and a communication interface. The terminal executes user interface software, which can be implemented as a web browser or a native application. The terminal presents a visual user interface configured to receive user information and to display travel plan information.

The user operates the terminal to input user information, including, for example, a travel schedule, a stay location, a number of travelers, a budget, a transportation method, and preference conditions. The terminal converts the user information into structured request data and transmits the request data to the server via the communication network using a secure communication protocol. The terminal displays, on the display device, travel plan candidate information and detailed travel plan structured data received from the server.

The server receives user information from the terminal and stores the user information in a storage device. The server normalizes the user information to generate search condition data. The server converts date strings representing a departure date and a return date into internal date objects and computes a number of travel days as a difference between the dates. The server converts a budget string into a numeric cost value in a unified currency based on stored exchange-rate parameters. The server derives destination attributes from the stay location, for example by mapping the stay location to region codes, city category, and activity categories using lookup tables stored in the database management system. The server thereby generates search condition data including at least a number of travel days, a cost range derived from the budget, and destination attributes.

The server accesses the information storage device implemented as a database management system to retrieve travel plan candidate data that matches the search condition data. The server uses a database access library to construct queries specifying conditions on destination, duration, cost, and transportation type. The server uses indexes defined on destination columns, duration columns, and cost columns to accelerate query execution. The server receives, from the database management system, a plurality of travel plan candidate data items, each including at least a destination, a duration, a cost range, activity categories, and lodging categories.

The server performs ranking processing on the extracted travel plan candidate data items. The server computes, for each travel plan candidate, a degree of match score as a weighted sum of partial similarity scores. The server computes, for example, a destination match score based on an exact match or a regional match, a duration match score based on the difference between the user's number of travel days and the candidate's duration, and a budget match score based on inclusion of the user's budget within the candidate's cost range. The server stores weighting coefficients for each partial similarity score in the storage device and applies these coefficients to calculate the degree of match. The server sorts the plurality of travel plan candidate data items according to the degree of match and generates candidate list data including at least an identifier, summary information, required days, and cost information for each candidate. The server transmits the candidate list data, in a structured data format, to the terminal so that the terminal presents a ranked list to the user.

The user observes the candidate list data displayed on the terminal and selects at least one travel plan candidate. The user then inputs a natural language prompt sentence to request generation or refinement of a detailed travel plan. The user may input, for example, the following prompt sentences:

“Tell me more details about this 5-day Paris trip, with museums in the morning and local restaurants in the evening.”

“Generate a detailed 7-day travel plan in Tokyo for a family of four, including kid-friendly activities and nearby restaurants.”

“Create a 3-day budget-friendly itinerary in New York City with a focus on free or low-cost attractions.”

“Make a 10-day honeymoon trip plan in Italy visiting Rome, Florence, and Venice, including romantic dinners and wine tastings.”

The terminal combines the selected travel plan candidate identifier and the prompt sentence and transmits them to the server as a request for detailed travel plan generation.

The server receives the selection result and the prompt sentence and generates generation instruction information. The server retrieves, from the database management system, attribute information for the selected travel plan candidate, including at least the destination, duration, base cost, base activities, and lodging type. The server analyzes the prompt sentence using a natural language processing module executed on the server. The server performs tokenization, part-of-speech tagging, and named-entity recognition to detect phrases corresponding to travel day change requests, cost adjustment requests, activity type change requests, and target-person attribute change requests. For example, the server interprets a phrase such as “more kid-friendly activities” as a target-person attribute change request indicating family-oriented preferences, and a phrase such as “budget-friendly” as a cost adjustment request. The server combines the detected requests with the attribute information and the original user information to construct structured generation instruction information including, for example, a desired activity emphasis, constraints on total cost, and traveler attributes.

The server creates prompt data for a generative AI model by a prompt generation module. The server organizes the prompt data as a sequence of messages including system-level instructions, context descriptions derived from the travel plan candidate attribute information, and user-level instructions derived from the prompt sentence. The server may, for example, generate prompt data that expresses a system role description, a summary of the selected plan, the normalized travel conditions, and explicit constraints on daily structure. The server thereby forms input data that is both natural-language and structured, guiding the generative AI model to generate output consistent with existing travel plan candidate data and user requests.

The server inputs the prompt data to a generative AI model. In one embodiment, the generative AI model is implemented as a neural network with a transformer-based architecture including multiple self-attention layers, feed-forward layers, and layer normalization components. The generative AI model has been trained in advance on large-scale text corpora including travel-related descriptions, schedule representations, and dialogue-like instructions. During training, the generative AI model uses a loss function such as a cross-entropy loss over predicted tokens, and the server or a training platform performs backpropagation to update weight parameters of the neural network. The server, or another training device, uses an optimization algorithm such as stochastic gradient descent or an adaptive gradient method, and may apply regularization techniques and data augmentation techniques, including paraphrasing and random masking, to improve generalization.

During inference, the server provides the prompt data to the generative AI model executed on specialized hardware such as a graphics processing unit or a tensor processing unit. The generative AI model processes a sequence of tokens representing the prompt data and generates a sequence of output tokens representing detailed travel plan data. The generative AI model conditions later token generation on both the original prompt and previously generated tokens, thereby producing coherent day-by-day activity contents and time-zone-specific activity proposals.

The server acquires the detailed travel plan data from the generative AI model and converts the generated natural-language output into a structured representation. The server identifies day markers and time-zone markers (for example, “Day 1-Morning,” “Day 1-Afternoon,” “Day 1-Evening”) by applying pattern matching and parsing rules. The server segments the generated text accordingly and populates activity content fields and recommended facility fields for each time zone of each day. The server thereby forms detailed travel plan structured data that enumerates activities and facility usage proposals on a per-day and per-time-zone basis.

The server further enriches the detailed travel plan structured data by integrating weather information data and event information data. The server calls an external information supply device providing weather information data, specifying at least the destination and the travel dates. The server receives forecast values for temperature, precipitation probability, and weather conditions for each day. The server also calls another external information supply device providing event information data, specifying at least the destination and the travel dates, and receives lists of scheduled events including event names, locations, and time slots. The server associates relevant weather conditions and events with the corresponding days and time zones in the detailed travel plan structured data, and writes corresponding annotations into weather-related annotation fields and event-related annotation fields. For example, the server may add a note such as “Rain expected in the afternoon; prioritize indoor museum activities” or “Local festival near the central plaza in the evening.”

The server transmits the detailed travel plan structured data to the terminal. The terminal receives the structured data and displays it as a multi-day representation, showing, for each day, morning, afternoon, and night sections with associated activities, facilities, and annotations. The terminal may also convert parts of the structured data into map links or reservation links. Because the data is structured, the terminal can efficiently filter, collapse, or reorder sections without performing complex natural language analysis.

The server thereby improves computer technology in several respects. The server reduces redundant computation by normalizing user information into search condition data and performing a database search and ranking process before invoking the generative AI model. This avoids asking the generative AI model to generate basic structural information that already exists in the database, thereby reducing the number of tokens processed by the model and lowering computational load on the model hardware. The server reduces communication load between the server and the terminal by transmitting ranked candidate list data and compact structured data instead of unstructured, verbose text. The server improves data management by maintaining detailed travel plan structured data in a machine-readable format, enabling efficient storage, indexing, and partial reuse of travel plan segments.

The server improves processing accuracy by combining deterministic retrieval and ranking algorithms with the generative AI model. The server constrains the generative AI model by embedding database-derived attributes and normalized constraints into the prompt data, thereby reducing the likelihood of generating inconsistent or infeasible travel plans. The server exploits a non-conventional workflow in which rule-based ranking and structured prompt generation precede and shape neural text generation, which is different from conventional systems that merely forward user text to a model.

The server further uses analysis of prompt sentences to detect specific requests, such as travel day change requests or cost adjustment requests, and to construct extended generation instruction information. By encoding these requests as explicit features in the prompt data, the server allows the generative AI model to treat them as structured conditions rather than relying solely on implicit interpretation. This technique improves the consistency between user intent and generated plans and reduces errors in duration or budget allocation.

The server can employ alternative embodiments. In one embodiment, the information storage device is implemented as a relational database system; in another embodiment, the information storage device is implemented as a document-oriented database system storing travel plan documents with nested fields. In one embodiment, the generative AI model is provided by an external model hosting service; in another embodiment, the generative AI model is deployed on-premise on a dedicated inference server with hardware accelerators. In one embodiment, the server uses a transformer-based neural network; in another embodiment, the server uses a hybrid neural network architecture combining recurrent units and attention layers, trained using a sequence-to-sequence objective tailored to itinerary data.

The server can additionally implement a feedback-based refinement mechanism, in which the server logs user selections, user satisfaction feedback, and subsequent prompt sentences. The server can use this log data to retrain or fine-tune the generative AI model using supervised or reinforcement learning techniques, adjusting model parameters to minimize a loss function that incorporates both generative accuracy and user satisfaction metrics. The server may also adjust ranking weights and prompt construction rules based on logged performance, thereby further improving computational efficiency and plan quality over time.

By using these structures and methods, the server does not simply automate human planning at a superficial level but reorganizes computation in a way that improves the efficiency of database querying, the effectiveness of neural text generation, and the reliability of structured data generation and transmission. The causal relationship is that the normalization and ranking stages reduce the search space and provide coherent context to the generative AI model; the structured prompt data encodes constraints explicitly; and the structured post-processing transforms generative output into machine-readable form. As a result, the system achieves faster response times, reduced model inference load, lower network traffic, and higher accuracy and consistency of generated travel plans compared with conventional systems that rely on simple keyword search and unstructured AI-generated text.

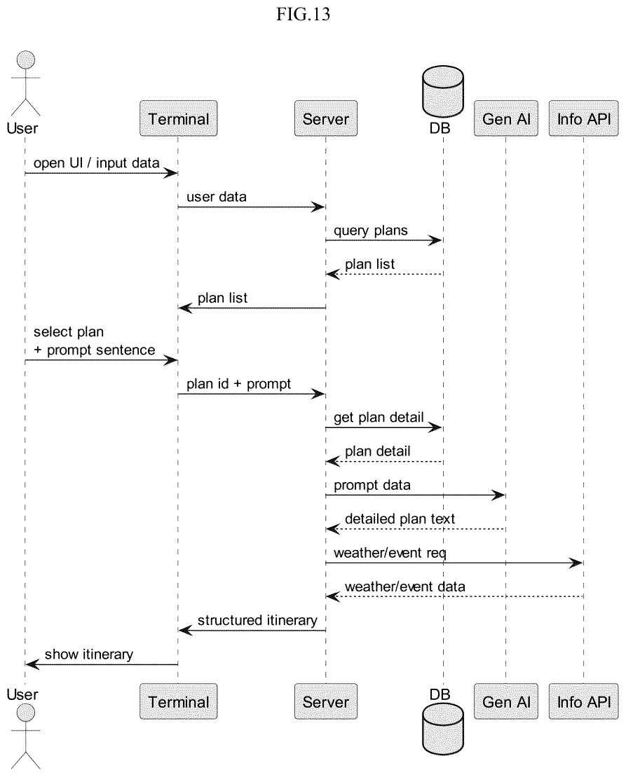

The following describes the processing flow using FIG. 13.

### Step 1

The user operates the terminal and opens a visual user interface provided by a web browser or a native application.

The user inputs travel schedule, stay location, number of travelers, budget, transportation method, and preference conditions into text fields, date pickers, and selection controls.

The terminal takes, as input, the raw user entries from the UI components, performs basic client-side validation (for example, date format check, numeric budget check), and converts the entries into an internal request object.

The terminal outputs a structured request payload including the user information and sends it to the server via a network request, for example using an HTTPS POST message.

### Step 2

The server receives, as input, the structured request payload from the terminal through a network interface.

The server parses the payload using an application framework, extracts fields such as departure date, return date, location string, budget string, and traveler count, and converts them into internal data structures.

The server performs data normalization: the server computes a number of travel days from the dates, converts the budget string to a numeric cost value in a standard currency, and derives destination attributes from the location string using a lookup table stored in a database.

The server outputs normalized search condition data including at least travel days, cost range, and destination attributes.

### Step 3

The server takes, as input, the search condition data and constructs a query for an information storage device implemented as a database management system.

The server generates a query that restricts destination, duration, cost, and transportation type according to the search condition data, and sends this query to the database via a database driver.

The database executes the query using internal indexing and returns a set of travel plan candidate records that satisfy the specified conditions.

The server outputs an internal list of travel plan candidate data items, each including at least destination, duration, cost range, activity categories, and lodging categories.

### Step 4

The server receives, as input, the list of travel plan candidate data items from the database.

The server computes, for each candidate, a degree of match by calculating partial similarity scores (for example, destination similarity, duration similarity, budget proximity) and combining them with stored weighting coefficients.

The server sorts the candidate list in descending order of the degree of match and trims or groups the list if necessary to limit the number of items.

The server outputs candidate list data including, for each candidate, at least an identifier, summary information, required days, and cost information, formatted as a structured response.

### Step 5

The server sends, as input to the communication module, the candidate list data in a structured data format such as a hierarchical object representation.

The server transmits the candidate list data to the terminal via a secure network channel.

The terminal receives the candidate list data, parses the structure, and generates UI elements such as cards or list rows from the fields (identifier, summary, required days, cost).

The terminal outputs a visual display of the candidate travel plans, allowing the user to scroll, inspect details, and select a desired plan.

### Step 6

The user examines the candidate list displayed on the terminal and selects at least one travel plan candidate using a selection control, such as a tap or click on an item.

The user then inputs a natural language prompt sentence into an input field associated with the selected plan to request detailed itinerary generation or refinement.

The terminal takes, as input, the user's selected plan identifier and the prompt sentence, and combines them into a detailed-plan request object.

The terminal outputs the detailed-plan request object and transmits it to the server using an HTTPS request.

### Step 7

The server receives, as input, the detailed-plan request object including the selected plan identifier and the prompt sentence.

The server queries the database for the full attribute information of the selected travel plan candidate, using the identifier as a key, and retrieves base itinerary structure, cost data, activity categories, and lodging details.

The server passes the prompt sentence to a natural language processing module, which tokenizes the sentence, performs part-of-speech tagging, and detects expressions indicating requested changes, such as “extend by two days,” “more kid-friendly,” or “cheaper restaurants.”

The server combines the extracted request information with the retrieved plan attributes and the normalized user conditions to output generation instruction information that encodes constraints and preferences in a structured form.

### Step 8

The server takes, as input, the generation instruction information and constructs prompt data for a generative AI model by a prompt generation module.

The server builds a multi-part textual prompt that includes system-level instructions (for example, role as a travel planner), a structured summary of the selected plan (destination, duration, budget, main activities), and a clear statement of the user's additional requirements inferred from the prompt sentence.

The server may include explicit tokens or markers to delimit days and time zones (morning, afternoon, night) so that the generative AI model can output a well-structured itinerary.

The server outputs prompt data in a format required by the generative AI model interface, ready to be sent for inference.

### Step 9

The server sends, as input to the generative AI model, the constructed prompt data via a model interface, for example through an API endpoint or an internal inference engine.

The generative AI model, implemented as a trained neural network with a transformer architecture, processes the tokenized prompt data, applies attention mechanisms, and computes output token probabilities layer by layer according to stored weight parameters.

The generative AI model generates an output token sequence that corresponds to detailed travel plan data, including day-by-day activity contents, time-zone-specific activity proposals, and facility usage proposals.

The server receives the generated token sequence, decodes it into text, and outputs raw detailed travel plan text.

### Step 10

The server takes, as input, the raw detailed travel plan text generated by the generative AI model.

The server parses the text using pattern matching rules and structural markers, identifying day boundaries, time-zone labels, and activity descriptions.

The server maps each identified segment into a structured data object, creating fields such as day number, morning activity content, afternoon activity content, night activity content, and associated facilities.

The server outputs detailed travel plan structured data that represents the itinerary as a machine-readable, per-day and per-time-zone data structure.

### Step 11

The server takes, as input, the detailed travel plan structured data and the original travel schedule and destination information.

The server sends requests to external information supply devices for weather information data and event information data, providing destination and date range as parameters.

The server receives, from the external devices, daily weather forecasts and lists of scheduled events and matches them against the days and time slots in the structured itinerary based on location and time.

The server enriches the structured data by writing weather-related annotations and event-related annotations into dedicated fields for each day and time zone, and outputs an enhanced detailed travel plan structured data set.

### Step 12

The server transmits, as input to the network interface, the enhanced detailed travel plan structured data in a structured format suitable for client rendering.

The server sends this enhanced data to the terminal via the communication network.

The terminal receives the enhanced structured data, parses its fields, and renders a multi-day, time-zone-separated view, including activities, recommended facilities, weather notes, and event notes, using UI components such as expandable panels or timelines.

The terminal outputs the final visual representation to the display, and the user can review, refine via additional prompt sentences, or save the generated travel plan based on the displayed structured information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented travel planning systems generally retrieve travel plans from a data repository based only on explicit user conditions, such as dates, destinations, and budgets, and then present the retrieved plans to a user terminal in a fixed format. In such systems, a server typically executes a search process according to static filtering or ranking rules and transmits unmodified or only minimally adjusted travel plan data to the terminal. As a result, these systems suffer from several technical limitations at the level of information processing architecture.

First, the server-side ranking and selection logic does not exploit rich contextual signals, such as the emotional state of the user inferred from user input data. The server often treats text, audio, and image input merely as parameter values for search, without leveraging them as high-dimensional signals that can be used to dynamically adjust search weights or plan selection strategies. This leads to suboptimal use of computing resources, because the system performs the same type of search and ranking operations irrespective of user context, and the server cannot adapt its internal data retrieval and processing pipeline to different user states.

Second, conventional systems do not tightly integrate external contextual information, such as weather information or event information at a destination, into the core plan generation pipeline at the server. Typically, weather information and event information, when used at all, are obtained in separate, loosely-coupled components and are merely shown alongside a travel plan. This architecture prevents the server from using such external information as structured input to the logical and generative components that construct the travel plan. As a consequence, the resulting data objects and network messages are fragmented, and the server cannot efficiently generate a coherent, optimized travel plan that accounts for dynamic external conditions.

Third, existing systems do not use generative models in a way that is structurally integrated into the back-end processing pipeline. In many cases, generative models, if used, are invoked manually or via ad hoc prompts that are not systematically constructed from structured data, emotion information, and external context. The server therefore cannot programmatically generate prompt sentences that accurately reflect the current user conditions, the inferred emotional state, and updated contextual information, and cannot reliably obtain machine-generated travel plans with predictable structure and constraints. This reduces reproducibility of behavior and complicates server-side validation and post-processing of generated plans.

Fourth, prompt generation logic in conventional systems is static or hard-coded, and is not designed to dynamically adjust the contents and the output format of the prompt sentence based on analysis of the user condition information and emotion information. This lack of dynamic constraint control causes inefficiencies in communication between the server and the generative model, leading to generated outputs that may not match the server's expected structure, thus requiring additional parsing and correction steps or manual intervention.

Accordingly, there is a need for a computer-implemented system and server-side architecture that: (i) programmatically infers and uses user emotion information from multimodal condition information; (ii) integrates external information sources such as weather information and event information at the data structure level together with candidate travel plan information; (iii) generates, on the server, structured prompt sentences for a generative information processing model based on unified internal representations; and (iv) dynamically adjusts prompt contents and output format constraints in response to analysis of condition information and emotion information. By addressing these issues, the system can improve the efficiency, adaptability, and technical quality of the server-side travel plan generation process and of the data exchanged between the server and the terminal.

The specific processing by the specific processing unit 290 of the data processing device 12 in Application Example 2 is realized by the following means.

The present invention provides a server comprising a processor configured to cause a terminal to display an information presentation screen for input of condition information related to a trip, to receive the condition information and associated user identification information from the terminal and store the condition information in an information storage apparatus, to search, based on the stored condition information, travel-related information in the information storage apparatus and extract candidate travel plan information, to estimate an emotional state of the user by analyzing at least one of text information, voice information, and image information included in the condition information and generate emotion information representing the emotional state, to adjust a priority of the candidate travel plan information by applying weighting to attribute information associated with the candidate travel plan information on the basis of the condition information and the emotion information so as to determine prioritized candidate travel plan information, to acquire weather information and event information related to a destination corresponding to the prioritized candidate travel plan information from an external information providing apparatus and associate the weather information and the event information with the prioritized candidate travel plan information, to generate a prompt sentence for input to a generative information processing model based on the condition information, the emotion information, the prioritized candidate travel plan information, and the associated weather information and event information, to input the prompt sentence to the generative information processing model and cause the generative information processing model to generate travel plan information including travel plan description information comprising daily activity contents and approximate costs, and to convert the travel plan information into a structured data format and transmit the structured data to the terminal. This enables a technical improvement in the server-side travel planning process by unifying multimodal user input, emotion estimation, database search, external context acquisition, and generative model interaction into a coherent pipeline, thereby allowing the server to generate context-aware, structurally consistent, and dynamically optimized travel plan data objects that are efficiently transmitted to and rendered by the terminal.

The term “processor” refers to a hardware or virtual computation unit, such as a central processing unit or an execution core in an information processing apparatus, that executes program instructions to perform the functions described in the present specification.

The term “terminal” refers to an information processing device, such as a mobile communication device, a portable computing device, or a display-equipped client device, that is configured to communicate with the server and to present information to a user and receive input from the user.

The term “information presentation screen” refers to a graphical user interface displayed on the terminal that includes one or more user interface components for displaying information and for receiving condition information input from a user.

The term “condition information” refers to information related to a planned trip, including at least one of a departure date, a return date, a number of travelers, a departure location, a destination, a means of transportation, a budget, and desired activities, as well as optional free-form textual, audio, or image data expressing user preferences.

The term “user identification information” refers to information that enables the association of condition information with a particular user, such as a user identifier, a session identifier, or other authentication-related data.

The term “information storage apparatus” refers to a logical or physical storage subsystem, such as a database system or file storage system, configured to store and manage condition information, travel-related information, emotion information, and travel plan information.

The term “travel-related information” refers to structured information stored in the information storage apparatus that is relevant to travel planning, including itinerary templates, accommodation information, transportation options, activities, prices, locations, tags, and other metadata associated with travel plans.

The term “candidate travel plan information” refers to travel-related information that has been retrieved from the information storage apparatus based on the condition information and that represents one or more potential travel plans for the user.

The term “text information” refers to character-based data, including but not limited to free-form natural language input, labels, or keywords, that is included in or derived from the condition information.

The term “voice information” refers to audio data, or data derived from audio signals, that is obtained from a user's speech and is included in or associated with the condition information.

The term “image information” refers to still image data, moving image data, or video frame data that captures a user or a surrounding environment and is included in or associated with the condition information.

The term “emotional state” refers to a state or tendency of a user's affect or mood, such as joy, excitement, calmness, stress, or a desire for relaxation, inferred from analysis of text information, voice information, or image information.

The term “emotion information” refers to data representing a user's emotional state, including at least one of a category label, a confidence value, and a numerical score, generated by analyzing the condition information.

The term “attribute information” refers to metadata or descriptive information associated with the candidate travel plan information, including tags, categories, feature scores, and classification labels that describe characteristics of each candidate travel plan.

The term “priority of the candidate travel plan information” refers to an order, ranking, or weighting assigned to each candidate travel plan based on matching with the condition information and the emotion information.

The term “prioritized candidate travel plan information” refers to candidate travel plan information whose priority has been adjusted according to the attribute information and the emotion information and that is selected or ordered for further processing.

The term “external information providing apparatus” refers to a system or service external to the server that provides contextual information such as weather information and event information in response to a query including at least destination and schedule data.

The term “weather information” refers to information indicating meteorological conditions for a destination and schedule, including at least one of temperature, precipitation, wind, and weather forecasts.

The term “event information” refers to information regarding scheduled activities, events, or happenings at or near a destination, including at least one of event names, dates, locations, and categories.

The term “prompt sentence” refers to character-based data that is constructed by the processor and provided as input to a generative information processing model, the prompt sentence describing at least the condition information, the emotion information, the prioritized candidate travel plan information, and associated contextual information, and specifying constraints on the content and output format of generated data.

The term “generative information processing model” refers to a machine learning model, such as a generative model based on neural network technology, configured to receive a prompt sentence as input and to generate travel plan information including natural language text or structured data as output.

The term “travel plan information” refers to data generated by the generative information processing model that describes at least one travel plan, including travel plan description information, daily schedules, recommended activities, and approximate costs.

The term “travel plan description information” refers to natural language text or formatted text that specifies day-by-day activities, times, locations, and other details of a travel plan.

The term “structured data format” refers to a machine-readable representation of data, such as a hierarchical or tabular format including at least one of a markup format and a notation format, that enables the terminal to programmatically interpret and display travel plan information.

The term “list screen” refers to a user interface screen displayed on the terminal that visually presents multiple travel plan options, each represented in a summarized form.

The term “detail screen” refers to a user interface screen displayed on the terminal that visually presents detailed information for one selected travel plan, including travel plan description information, weather information, and event information.

The term “settlement information” refers to information used to process a purchase transaction for a selected travel plan, including at least payment-related information and transaction parameters.

The term “external settlement processing apparatus” refers to a system or service external to the server that executes financial transaction processing based on settlement information, such as an online payment processing system.

The term “prompt generation function unit” refers to a functional component executed by the processor that analyzes condition information and emotion information and dynamically determines contents and output format constraints of a prompt sentence to be input to the generative information processing model.

In one embodiment, a server, a plurality of terminals, and at least one communication network cooperate to implement the claimed system. The server comprises at least one processor, a main memory, a non-volatile storage unit, and a network interface. The processor executes program instructions stored in the non-volatile storage unit to realize functional modules including a user interface control module, a condition information management module, a travel information retrieval module, an emotion estimation module, a ranking adjustment module, an external information acquisition module, a prompt generation function unit, a generative AI interface module, and a response generation module. The non-volatile storage unit stores an information storage apparatus implemented as a relational database and one or more trained generative AI models and emotion estimation models.

The terminal comprises a processor, a display, an input device such as a touch panel, a microphone, and optionally a camera. The terminal executes an application, for example implemented using a mobile application framework such as a cross-platform user interface library, or a web browser executing client-side scripts and markup language documents, to present screens generated by the server and to capture condition information from the user.

The user operates the terminal to input condition information. The terminal displays an information presentation screen including graphical components such as date selectors, location fields, numeric fields for number of travelers and budget, selection components for means of transportation, and free-text input areas for desired activities. The terminal may display these components using markup languages and style sheets, or using native user interface components provided by an operating system framework. The terminal sends the input condition information, together with user identification information, to the server via a secure transport protocol over the network.

The server receives the condition information by the user interface control module. The condition information includes structured parameters, such as departure date, return date, number of travelers, departure location, destination, means of transportation, budget, and identifiers for desired activities, and may further include free-form text expressing preferences, as well as audio or image data representing the user's speech or facial expression. The condition information management module stores these data elements into the information storage apparatus implemented using a relational database management system, such as a system using structured query language. The server normalizes and indexes the data so that later retrieval operations can be executed using efficient query plans.

The travel information retrieval module retrieves travel-related information from the information storage apparatus. The travel-related information includes structured records representing candidate travel plans, each record including fields for itinerary structure, accommodation options, transportation segments, activities, prices, locations, and attribute information such as tags and categories. The travel information retrieval module executes query language statements constructed from the condition information. For example, the travel information retrieval module generates a query including predicates for date range, departure location, destination, price range computed from the budget and number of travelers, and means of transportation. The module may further apply full-text search or inverted-index search over tags and descriptions to identify plans that contain desired activities such as museums, hot springs, beaches, or theme parks. The output of this module is candidate travel plan information representing one or more potential trips satisfying the explicit conditions.

The emotion estimation module analyzes at least one of text information, voice information, and image information included in the condition information to estimate an emotional state for the user. In one embodiment, the server uses a text-based emotion classifier implemented as a neural network, such as a recurrent neural network or a transformer-based network, trained on labeled text corpora that associate sentences with emotional categories. The server converts the free-form text of the condition information into token sequences, applies word or sub-word embeddings, and inputs the embedded sequences into the neural network. The network outputs probability distributions across emotion labels such as joy, excitement, frustration, or desire for relaxation. The server selects the label with the highest probability and records the associated confidence value as part of the emotion information.

In another embodiment, the emotion estimation module analyzes voice information. The server uses a speech-to-text engine to convert audio segments into text and further computes acoustic features such as fundamental frequency, energy, spectral centroids, and temporal statistics. The server aggregates these features into a feature vector and inputs the vector into a neural network classifier, for example a convolutional neural network operating on spectrograms or a recurrent neural network operating on time-series feature vectors. The classifier outputs emotion classifications that complement the text-based results. Similarly, the server can use a vision-based classifier to analyze facial expressions from images or video frames, using a convolutional neural network or similar architecture trained to map facial feature landmarks to emotion labels.

The emotion estimation module combines these multiple outputs into a unified emotion information object. For example, the module may apply a weighted voting algorithm or another fusion strategy to compute a primary emotional state and a confidence score. The server stores this emotion information in the information storage apparatus in association with the corresponding condition information.

The ranking adjustment module adjusts priorities of candidate travel plan information based on the emotion information. For each candidate plan, the server evaluates attribute information, such as tags indicating “relaxation,” “adventure,” “family-friendly,” or “nightlife.” The server maintains a mapping between emotion labels and attribute weight vectors; for example, a “seeking relaxation” emotion may cause the server to assign a positive weight to relaxation and nature tags and a negative weight to intensive sightseeing tags. The ranking adjustment module computes a composite score for each candidate plan by combining an explicit-condition match score and an emotion-based attribute score, for instance by a weighted linear combination or by a learned ranking function. The module then orders the candidate travel plan information according to the composite scores and selects one or more prioritized candidate travel plan information entries as primary candidates for further refinement.

The external information acquisition module augments the prioritized candidate travel plan information with context obtained from external information providing apparatuses. The server determines destination locations and date ranges from the prioritized candidate travel plan information and sends requests via application programming interfaces to external systems that provide weather forecasts and event schedules. The module parses responses containing, for example, forecast temperatures, precipitation probabilities, and scheduled events such as festivals, exhibitions, or concerts. The module attaches these contextual data to corresponding travel plan entries as structured fields. By integrating these external data at the data structure level, the server ensures that subsequent processing, including prompt generation, can treat weather information and event information as part of a unified representation, rather than as merely decorative annotations.

The prompt generation function unit constructs a prompt sentence for a generative AI model based on a unified representation of condition information, emotion information, prioritized candidate travel plan information, and external contextual information. The server encodes this representation into a natural language or semi-structured text that describes the user's constraints, preferences, and emotional state, summarizes key attributes of the candidate plans, and specifies desired output format constraints. The prompt generation function unit analyzes the condition information and emotion information and dynamically adjusts both the content and the structure of the prompt sentence. For example, when the emotion information indicates a desire for relaxation, the prompt generation function unit may explicitly instruct the generative model to prioritize relaxing activities and avoid dense schedules, while, in other cases, it may emphasize variety or high activity levels.

An example of such a prompt sentence is:

“You are a travel planner generative AI model.

The user has provided the following information:
Origin: Osaka
Destination: Tokyo
Departure date: 2026 Mar. 15
Return date: 2026 Mar. 17
Number of travelers: 2
Transport: shinkansen
Budget: 50,000 yen per person
Preferences: visit a hot spring and museums
Emotion: seeking relaxation

Based on these conditions and assuming average prices, generate a detailed 2-day travel plan that fits within the budget.

Output format:

Day 1:
Morning: [activity, location, approximate cost]
Afternoon: [activity, location, approximate cost]
Evening: [activity, location, approximate cost]

Day 2:
Morning: [activity, location, approximate cost]
Afternoon: [activity, location, approximate cost]
Evening: [activity, location, approximate cost]

Prioritize relaxing experiences, such as hot springs and quiet museums, and avoid overly busy schedules.”

The generative AI interface module transmits the prompt sentence to a generative information processing model. In one embodiment, the generative model is a transformer-based language model trained on large corpora of travel-related text and schedule structures. The model uses multi-head self-attention layers and feed-forward layers with positional encoding to map the prompt token sequence to an output token sequence representing the travel plan description. The model is fine-tuned on domain-specific travel itineraries so that generated text adheres to day-by-day planning conventions and respects constraints encoded in the prompt, such as budgets and date ranges.

During training, the generative model minimizes a loss function such as cross-entropy between predicted tokens and reference tokens of training itineraries. The training process uses gradient-based optimization, for example stochastic gradient descent with adaptive learning rate and regularization techniques such as dropout and weight decay. Data augmentation techniques may be applied to the training data, such as perturbing dates, budgets, or activity labels, to improve robustness. The model parameters, such as layer weights and biases, are stored in the server's storage and loaded into memory during inference.

At inference time, the generative AI interface module tokenizes the prompt sentence, maps tokens to embeddings, and passes them through the trained layers of the generative model. The module uses decoding strategies such as beam search or top-k sampling to generate coherent and diverse travel plan descriptions while keeping costs within specified limits. The module returns the generated text to the prompt generation function unit or the response generation module.

The response generation module converts the generated text into travel plan information. The module may parse the text delimitation markers specified in the prompt, such as “Day 1” and “Morning,” and transform the text into a structured representation, such as a hierarchical object with days, time slots, activities, locations, and cost estimates. The module associates the structured plan with underlying candidate plan identifiers and with the contextual weather and event information obtained earlier. The result is travel plan information that includes both human-readable descriptions and machine-readable fields.

The server transmits this structured travel plan information to the terminal. The terminal receives the structured data and renders list screens and detail screens. The terminal displays summarized information for each generated plan on a list screen, such as plan title, estimated total cost, and key highlights, and, in response to user selection, displays full day-by-day itineraries on a detail screen, including weather summaries and event lists. The terminal may cache some of the structured data locally to reduce repeated network requests and to improve responsiveness.

In some embodiments, the terminal further enables the user to select a generated travel plan and initiate a purchase. The terminal collects settlement information, including payment data, and transmits this to the server. The server communicates with an external settlement processing apparatus using payment processing protocols to execute the transaction and, upon success, records booking identifiers and confirmation codes in the information storage apparatus. The server then returns confirmation information to the terminal, which displays it to the user.

The described configuration provides technical improvements beyond mere automation of human travel planning. The server restructures the back-end pipeline in a way that unifies multimodal condition input, emotion estimation, dynamic ranking, external context integration, and generative model interaction. By structuring condition information, emotion information, candidate plan information, and contextual information into unified data representations and by using these as the basis for prompt sentence construction, the server improves the accuracy and efficiency of travel plan generation. The generative AI model receives well-constrained prompt sentences that reflect current user context and server-side constraints, resulting in outputs that require less post-processing and fewer corrective requests, thereby reducing computation and communication overhead.

Furthermore, the emotion estimation and ranking adjustment modules implement non-conventional rules and algorithms that differ from typical human decision-making. For example, the server applies mathematically defined weight vectors and ranking functions derived from model outputs rather than simple rule-of-thumb heuristics. This enables fine-grained control of travel plan ordering based on quantitatively evaluated attribute information and emotion information, which yields more stable and predictable plan selection than manual curation.

By incorporating the external information acquisition module into the core pipeline, the server can generate travel plans that inherently account for weather forecasts and event schedules at the algorithmic level. This reduces the need for manual cross-checking by users and prevents inconsistent or outdated plan suggestions, which in turn improves the reliability of the generated plans. The unified data structures and processing sequence also allow caching of external information keyed by destination and date, which can reduce repeated network calls and lower communication load.

The use of a transformer-based generative AI model with domain-specific fine-tuning, combined with structured prompt sentences, constitutes a concrete technical improvement in how the server generates and manipulates natural language itineraries. The model produces text that is aligned with the server's structural expectations, such as explicit day-by-day segmentation, which facilitates deterministic parsing and conversion into structured data. This reduces parsing errors and improves downstream processing speed, because the server no longer needs to rely on generic, error-prone natural language parsers.

In another embodiment, the server uses alternative model architectures, such as sequence-to-sequence recurrent neural networks with attention, or encoder-decoder architectures based on convolutional networks, in place of or in addition to transformer-based models. The server may maintain multiple generative models optimized for different types of trips, such as short weekend trips or long multi-city tours, and select an appropriate model based on the condition information. This model selection further improves computational efficiency by limiting inference to models specialized for particular contexts.

The system may also include variations in how emotion information is used. In one variation, the emotion estimation module outputs continuous scores along multiple affective dimensions such as arousal and valence rather than discrete labels. The ranking adjustment module then applies a continuous mapping from these scores to weight adjustments for attribute information, allowing smoother control over the prioritization of candidate plans. This continuous treatment of emotion improves the stability and granularity of plan ranking and avoids abrupt changes when user emotion estimations are near label boundaries.

The configuration described above can be implemented on distributed server architectures, where some modules, such as the generative AI model and emotion estimation models, execute on specialized hardware accelerators such as graphics processing units or tensor processing units. The communication between modules uses serialized data structures with explicit schemas, which enable validation and debugging at module interfaces. By decomposing the system into modules with well-defined interfaces and by structuring internal data representations in a way aligned with the generative AI model's expectations, the invention improves the internal operation of the computer system itself and yields measurable benefits in processing speed, resource utilization, and output quality.

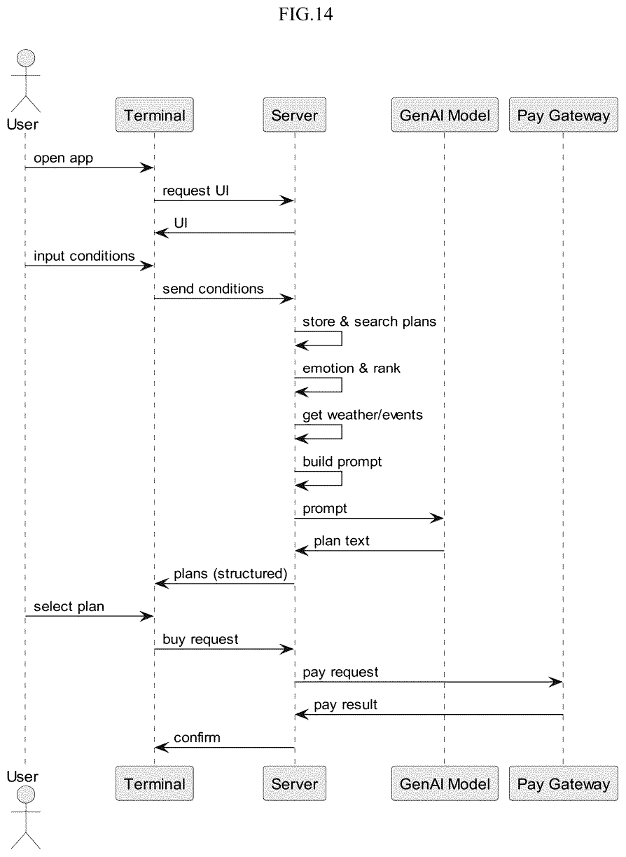

The following describes the processing flow using FIG. 14.

### Step 1

User operates the terminal to start a travel planning application and open an input screen.

User touches an application icon or accesses a web address, causing the terminal to launch an application or browser.

Input: no application-level input data yet; only a user interaction to start the app.

Terminal sends a request to the server to obtain a definition of an information presentation screen for condition information.

Terminal transmits, as output, a request message including at least a screen identifier and user identification information.

### Step 2

Server receives the screen request and generates an information presentation screen definition.

Server, as input, receives the request message including the screen identifier and user identification information.

Server retrieves, from an information storage apparatus, layout definitions, default values, and option lists for fields such as dates, locations, number of travelers, means of transportation, budget ranges, and activity categories.

Server performs data processing by combining layout templates with user-specific defaults (for example, last used origin or preferred currency) to build a structured screen definition.

Server outputs a structured representation (for example, JSON or a markup document) describing user interface components to the terminal.

### Step 3

Terminal renders the information presentation screen and receives condition information from the user.

Terminal, as input, receives the screen definition from the server.

Terminal constructs local user interface objects such as date pickers, dropdown lists, text boxes, and buttons, and displays them on the display.

User manipulates these objects by selecting a departure date, a return date, a number of travelers, a departure location, a destination, a means of transportation, a budget, and desired activities, and by optionally entering free-text comments.

Terminal converts the user's interactions into structured condition information.

If the user activates voice input, terminal records audio using the microphone and, if available, captures images or video frames using the camera.

Terminal outputs a condition information message to the server that includes structured fields, free text, user identification information, and optionally audio and image data.

### Step 4

Server receives and stores the condition information.

Server, as input, obtains the condition information message from the terminal.

Server validates field formats (for example, date consistency and numeric ranges) and extracts structured components and unstructured components (free text, audio, image).

Server performs a data processing operation by mapping fields into columns of one or more database tables, adding a timestamp and a user identifier.

Server executes an insertion operation in a relational database to store the condition information.

Server outputs a normalized condition information record stored in the information storage apparatus and a confirmation status to internal modules.

### Step 5

Server retrieves candidate travel plan information from the information storage apparatus.

Server, as input, uses the stored condition information (dates, locations, number of travelers, budget, and transportation constraints).

Server constructs a query in a query language that filters travel-related information by date range, origin, destination, price range computed from budget divided by number of travelers, allowable means of transportation, and presence of requested activity tags.

Server executes the query on tables containing travel-related information, such as itineraries, accommodations, transport segments, and activity offerings.

Server processes the query results by assembling each row and its related records into candidate travel plan objects, each including attribute information such as tags “relaxation,” “museum,” or “outdoor.”

Server outputs a list of candidate travel plan information objects to downstream modules.

### Step 6

Server estimates the user's emotional state from text information, voice information, and/or image information.

Server, as input, obtains free-text components, audio recordings, and image or video frames from the condition information record.

Server converts text into token sequences and numerical embeddings and feeds them into a text-based emotion classification model (for example, a neural network).

Server, when audio is present, extracts acoustic features such as pitch, energy, and spectral characteristics and, optionally, generates a spectrogram; server inputs these features into a voice-based emotion classifier.

Server, when image data are present, detects facial regions, computes facial feature vectors, and inputs them into an image-based emotion classifier.

Server performs data fusion by combining classifier outputs through a weighting or voting algorithm to compute a primary emotional state and a confidence score.

Server outputs emotion information, including at least one emotion label and a confidence value, and stores this emotion information associated with the condition information.

### Step 7

Server adjusts priorities of candidate travel plan information using the emotion information.

Server, as input, receives the list of candidate travel plan objects and the emotion information.

Server applies a mapping from the emotion label to weight coefficients for attribute information, for example increasing weights for “relaxation” and “nature” tags when the emotion is “seeking relaxation.”

Server computes, for each candidate plan, a base match score derived from how closely explicit conditions are met, and an emotion-based adjustment score derived from attribute weights.

Server performs a numeric computation by combining these scores (for example, via a weighted sum) to derive a composite priority score for each candidate plan.

Server sorts the candidate plans by composite score and selects a subset as prioritized candidate travel plan information.

Server outputs the prioritized candidate travel plan information list to the next module.

### Step 8

Server acquires weather information and event information from external information providing apparatuses.

Server, as input, uses the prioritized candidate travel plan information, including destination locations and travel date ranges.

Server sends requests to one or more external systems via application programming interfaces, specifying destination identifiers and date ranges as query parameters.

Server receives responses that include weather forecasts (temperature, precipitation probability, and conditions) and event schedules (event names, venues, and times).

Server parses the responses, converts the returned data into internal structures, and associates each piece of weather information and event information with the corresponding prioritized candidate travel plan.

Server outputs enriched travel plan objects that include contextual weather fields and event fields.

### Step 9

Server generates a prompt sentence based on unified condition information, emotion information, prioritized candidate travel plan information, and contextual information.

Server, as input, receives the stored condition information, the emotion information, and the enriched prioritized candidate travel plan objects.

Server's prompt generation function unit selects salient fields, such as origin, destination, dates, number of travelers, budget, and emotion label, and summarizes relevant characteristics of the prioritized plans.

Server performs a data transformation by placing these fields into a textual template that defines the constraints and desired output format.

Server dynamically modifies the template content and instructions depending on the emotion label and the complexity of the trip; for example, server adds phrases emphasizing relaxation when the emotion indicates a desire for rest.

Server outputs a prompt sentence expressed as natural language text intended for a generative AI model.

### Step 10

Server sends the prompt sentence to a generative AI model and receives generated travel plan description information.

Server, as input, uses the prompt sentence produced by the prompt generation function unit.

Server tokenizes the prompt sentence and, when using an internal generative model, maps tokens to embeddings and forwards them through a trained neural network configured as a generative information processing model; when using an external generative service, server transmits the prompt sentence via an interface.

Server performs a decoding procedure (for example, beam search) to generate an output sequence of tokens that represents travel plan description text, including daily activity contents and cost estimates.

Server converts the token sequence back into character strings forming coherent natural language descriptions and checks conformance to constraints such as budget and date range.

Server outputs generated travel plan description information associated with the corresponding prioritized candidate travel plan.

### Step 11

Server converts the generated travel plan information into a structured data format and prepares a response to the terminal.

Server, as input, uses the generated travel plan description information, the corresponding prioritized candidate travel plan object, and the associated weather information and event information.

Server parses structural markers within the generated text, such as “Day 1,” “Morning,” and “Evening,” and creates a hierarchical data structure with fields for days, time slots, activities, locations, and approximate costs.

Server embeds weather summaries and event lists into appropriate positions in this structure, for example associating events with specific days.

Server serializes the hierarchical structure into a structured data format, such as a hierarchical notation or markup, suitable for efficient transmission and rendering by the terminal.

Server outputs a response message containing the structured travel plan information and sends this message to the terminal.

### Step 12

Terminal receives the structured travel plan information and displays list and detail views to the user.

Terminal, as input, obtains the structured data message from the server.

Terminal parses the structured data into internal objects and constructs a list view that shows, for each plan, a title, a total cost, a short description, and icons or text summarizing weather and key events.

Terminal, when the user selects a plan from the list, constructs a detail view displaying the full day-by-day itinerary, activities, costs, and associated weather and event information.

Terminal performs graphical layout operations to arrange text, icons, and optional images on the display.

Terminal outputs visual representations of the travel plans to the user and accepts further user interactions such as scrolling and plan selection.

### Step 13

User selects a travel plan and initiates a purchase operation.

User reviews the displayed options and taps a control element such as a “Purchase this plan” button on the terminal screen.

Input to this step is the set of displayed travel plans and the user's selection action.

Terminal captures the identifier of the selected travel plan and triggers a transition to a payment input screen.

Terminal outputs selection information, including the plan identifier, to its internal payment handling module and prepares to send settlement information to the server.

### Step 14

Terminal collects settlement information and sends a purchase request to the server.

Terminal, as input, uses the selected plan identifier and prompts the user for payment details such as card number, expiration date, and security code, or selects a stored payment method.

Terminal validates the format of the entered data and may request tokenization from a payment software development kit.

Terminal constructs a purchase request containing the selected plan identifier and settlement information or a payment token.

Terminal outputs the purchase request message to the server via a secure channel.

### Step 15

Server processes the purchase request and completes the transaction using an external settlement processing apparatus.

Server, as input, receives the purchase request containing the plan identifier and settlement information or token.

Server verifies that the referenced travel plan is available and that prices and terms are current using the information storage apparatus.

Server constructs a transaction request to an external settlement processing apparatus and includes transaction amount, currency, and payment token.

Server receives a response from the external apparatus indicating approval or rejection and, if approved, records a booking entry and transaction identifier in the database.

Server outputs a confirmation message including booking details and transaction status and sends this message to the terminal, concluding the processing flow for the selected travel plan.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

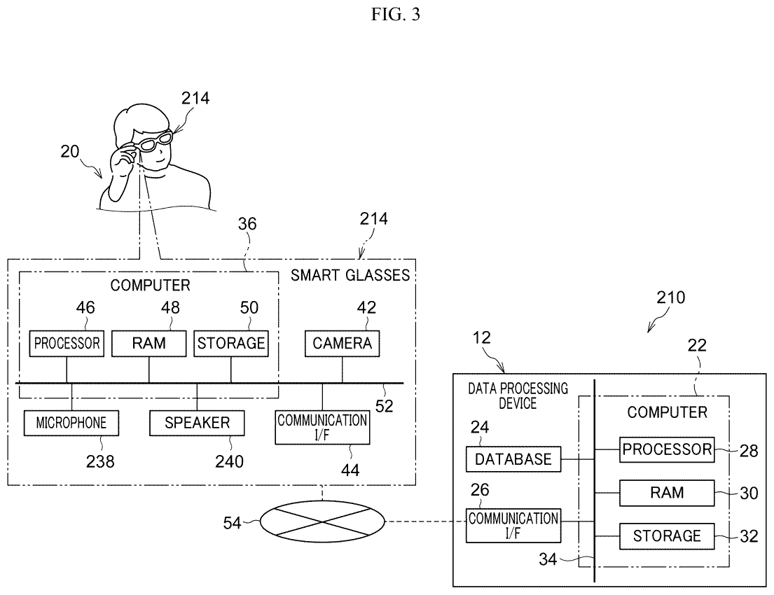

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

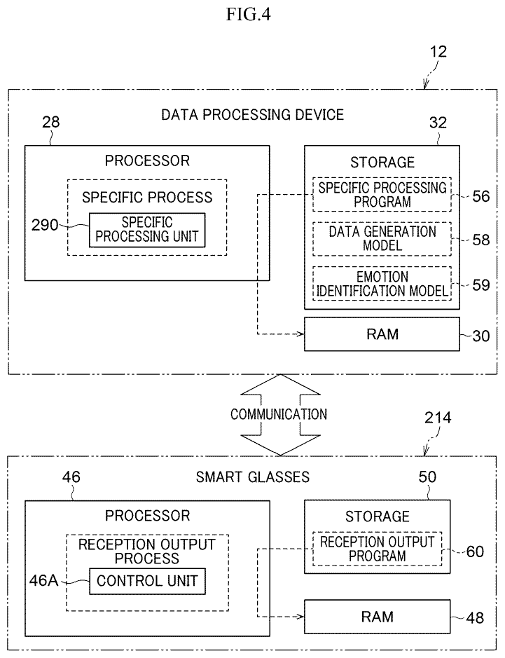

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

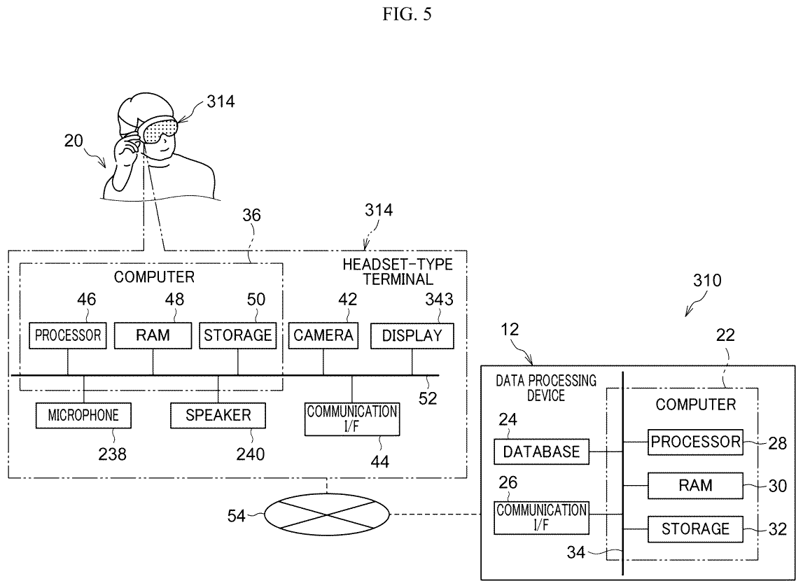

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

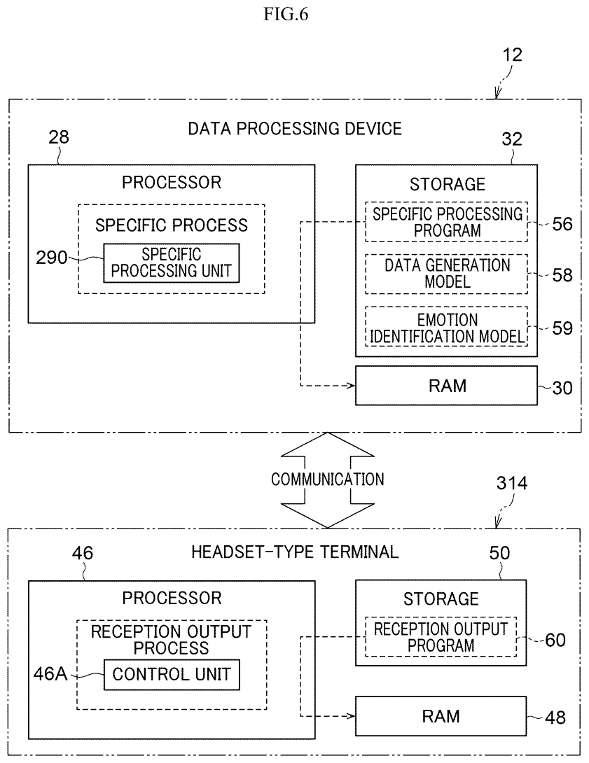

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

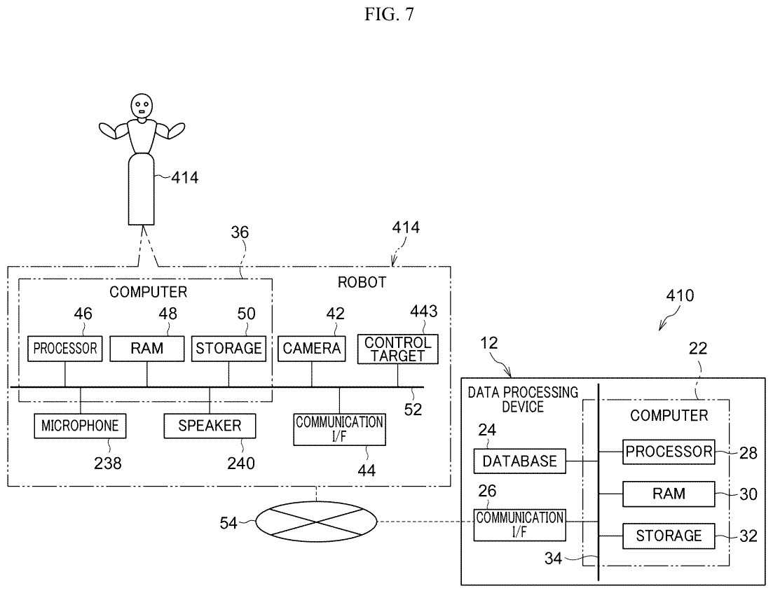

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

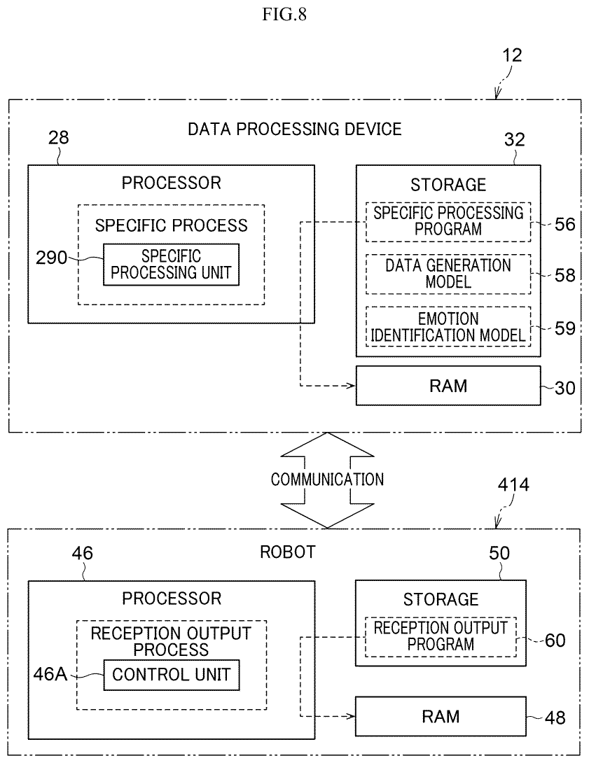

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

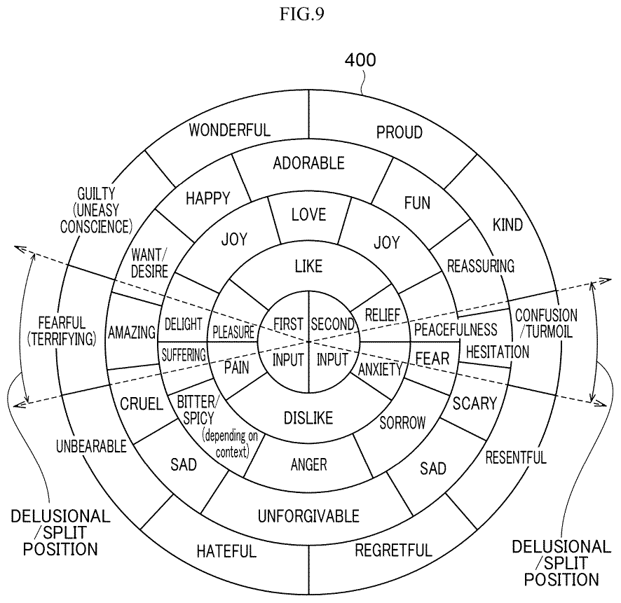

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

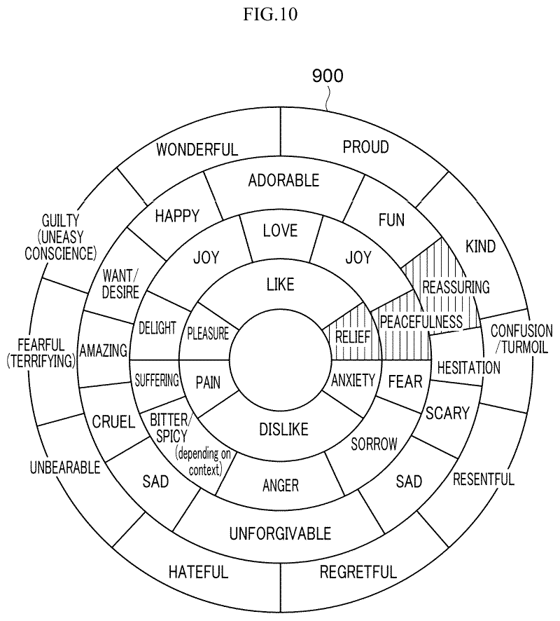

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide a screen-based input/output environment that allows a user to input travel conditions including a travel period, a number of participants, a travel mode, a departure location, and an arrival location,
receive, via the screen-based input/output environment, travel condition information transmitted from a user terminal as a request based on a communication protocol, convert the travel condition information into a structured record format, and store the structured record format in a storage device,
acquire, from the storage device, the stored travel condition information, calculate a number of travel days based on a travel start date and a travel end date, normalize the departure location, the arrival location, and the travel mode, and generate a structured data set,
generate, based on the structured data set, a prompt sentence for a generative AI model by inserting the number of travel days, the number of participants, the departure location, the arrival location, and the travel mode into predetermined positions of a sentence template, the prompt sentence being used to instruct the generative AI model to execute generation processing of a travel itinerary plan,
transmit, via a communication interface, the generated prompt sentence to a model processing unit included in the generative AI model and acquire a travel itinerary plan text generated by the generative AI model,
analyze the travel itinerary plan text and convert the travel itinerary plan text into a structured data format having a hierarchical structure including, for each day, an itinerary, activities for respective time periods, travel segments, and lodging candidates, and convert the structured data format into a data structure transmittable to the user terminal, and
transmit, via a communication path, the converted structured data format to the user terminal.

### Supplementary 2

The system according to supplementary 1,
wherein the processor is configured to cause the user terminal to analyze the structured data format received from the processor, dynamically generate display elements corresponding to per-day itineraries and activities included in the structured data format, visually arrange the display elements on a screen, update the screen-based input/output environment to accept correction input from a user, and re-transmit updated travel condition information corresponding to the correction input to the processor.

### Supplementary 3

The system according to supplementary 1,
wherein the processor is configured to include a prompt generation functional unit that, based on the travel condition information and the correction input from the user, changes the sentence template and constraint conditions of the prompt sentence, adds control instructions specifying a detail level of the travel itinerary plan, types of activities, a suppression condition for travel time, and an output format to the prompt sentence, re-inputs the prompt sentence to the generative AI model, and iteratively optimizes the travel itinerary plan generated by using the prompt sentence.

### Application Example 1

### Supplementary 1

A system comprising a processor and a communication interface,
wherein the processor is configured to
provide, to a terminal, a visual information input and output interface that allows a user to input schedule information relating to travel, participant number information, and transportation method information, and to receive, from the terminal, structured input data including the schedule information, the participant number information, and the transportation method information, cause the structured input data to be transmitted to a server via a communication line, parse and
validate the structured input data at the server, and execute a search process on an information storage device storing travel plan information and food and beverage delivery option information,
generate, based on the travel plan information acquired from the information storage device, a plurality of travel plan candidates, transmit the plurality of travel plan candidates in a structured data format to the terminal, and cause the plurality of travel plan candidates to be visually presented on the terminal while accepting a selection operation of a travel plan candidate by the user,
generate, based on a selected travel plan candidate, travel plan detail information corresponding to the selected travel plan candidate, and the schedule information, the participant number information, and the transportation method information, a prompt sentence that instructs a generative information processing model to generate food and beverage delivery options,
transmit a processing request including the generated prompt sentence to the generative information processing model, receive response information from the generative information processing model, and analyze the response information to generate structured delivery option data representing a plurality of food and beverage delivery options,
cause, based on the structured delivery option data, food and beverage delivery options grouped on a date unit basis and a meal category unit basis to be visually displayed on the terminal, and accept a selection operation of a food and beverage delivery option by the user, and
transmit, based on a food and beverage delivery option selected by the user, delivery arrangement request data including reservation information and order information to an external delivery service providing apparatus, receive arrangement completion information from the external delivery service providing apparatus, store the arrangement completion information, and notify the terminal of the arrangement completion information.

### Supplementary 2

The system according to supplementary 1,
wherein the processor is configured to
compare store information and item information included in the response information received from the generative information processing model with matching information stored in an external food and beverage providing service information providing apparatus or an internal information storage device, and, by the comparison, assign, to each of the food and beverage delivery options, provider identification information, price information, delivery time slot information, and evaluation information, and thereby generate the structured delivery option data.

### Supplementary 3

The system according to supplementary 1,
wherein the processor is configured to
generate the prompt sentence such that the prompt sentence includes constraint conditions specifying an output format as a list format or a table format and specifying that the food and beverage delivery options are to be output on the date unit basis and the meal category unit basis, based on the structured input data and the travel plan detail information.

### Example 2

### Supplementary 1

A system comprising a processor,
wherein the processor is configured to
provide, to a terminal, a visual user interface through which a user inputs travel conditions including at least a travel schedule, a stay location, a number of travelers, a budget, a transportation method, and preference conditions, and to receive, via a communication network, user information input through the visual user interface from the terminal,
store the received user information in a storage device, normalize the user information to generate search condition data including at least a number of travel days, a cost range, and destination attributes, query, on the basis of the search condition data, a database management device functioning as an information storage device for travel plan information, and extract a plurality of travel plan candidate data items that match the search condition data,
perform, for the plurality of extracted travel plan candidate data items, ranking processing based on a degree of match, generate candidate list data including at least an identifier, summary information, required days, and cost information for each travel plan candidate, and transmit the candidate list data, in a structured data format, to the terminal so that the candidate list data is visually displayed on the visual user interface,
generate, when the user selects at least one travel plan candidate from the candidate list data and transmits a natural language prompt sentence from the terminal together with a result of the selection, generation instruction information including attribute information relating to the selected travel plan candidate and the prompt sentence, and create prompt data to be input to a generative AI model on the basis of the generation instruction information by a prompt generation module,
input the prompt data to the generative AI model, cause the generative AI model to generate detailed travel plan data including at least day-by-day activity contents, time-zone-specific activity proposals, and facility usage proposals, and acquire the detailed travel plan data from the generative AI model, and perform a formatting process on the detailed travel plan data by associating and adding supplementary information based on weather information data and event information data acquired from an external information supply device, and converting the detailed travel plan data into detailed travel plan structured data that is structured on a per-day basis and is in a format transmittable to the terminal.

### Supplementary 2

The system according to supplementary 1,
wherein the processor is configured to
analyze the prompt sentence from the user, extract from the prompt sentence at least one of a travel day change request, a cost adjustment request, an activity type change request, or a target-person attribute change request, generate extended generation instruction information by combining an extraction result with travel plan candidate data relating to the selected travel plan candidate, and input, to the generative AI model, prompt data including the extended generation instruction information.

### Supplementary 3

The system according to supplementary 1,
wherein the processor is configured to
generate the detailed travel plan structured data, for each day, as a data structure including at least an activity content field for each of a morning time zone, an afternoon time zone, and a night time zone, a recommended facility field, a weather-related annotation field, and an event-related annotation field, transmit the data structure to the terminal, and cause the data structure to be presented, by the visual user interface on the terminal, in a display format that is separated by day and by time zone.

### Application Example 2

### Supplementary 1

A system comprising a processor,
wherein the processor is configured to
cause a terminal to display an information presentation screen for allowing a user to input condition information related to a trip,
receive the condition information and user identification information associated with the condition information from the terminal and store the condition information in an information storage apparatus,
search, on the basis of the condition information, travel-related information stored in the information storage apparatus that matches at least a departure date, a return date, a number of travelers, a departure location, a destination, a means of transportation, a budget, and desired activities, and extract candidate travel plan information,
estimate an emotional state of the user on the basis of at least one of text information, voice information, and image information included in the condition information, and generate emotion information representing the emotional state,
adjust a priority of the candidate travel plan information by applying weighting to attribute information associated with the candidate travel plan information on the basis of the condition information and the emotion information, and determine prioritized candidate travel plan information corresponding to the emotional state,
inquire, on the basis of a destination and a schedule corresponding to the prioritized candidate travel plan information, an external information providing apparatus to acquire weather information and event information related to the destination, and associate the weather information and the event information with the prioritized candidate travel plan information,
generate a prompt sentence for input to a generative information processing model on the basis of the condition information, the emotion information, the prioritized candidate travel plan information, and the associated weather information and event information, input the prompt sentence to the generative information processing model and cause the generative information processing model to generate travel plan information including travel plan description information comprising daily activity contents and approximate costs, and convert the travel plan information into a structured data format and transmit the structured data to the terminal.

### Supplementary 2

The system according to supplementary 1,
wherein the processor is configured to, using the structured data including the travel plan information and the associated weather information and event information transmitted to the terminal, cause the terminal to visually display a list screen and a detail screen, receive from the user a selection operation of a travel plan, acquire settlement information related to the selected travel plan, and execute a purchase process by using an external settlement processing apparatus.

### Supplementary 3

The system according to supplementary 1,
wherein the processor is configured to include a prompt generation function unit that analyzes the condition information and the emotion information and dynamically changes constraint conditions relating to contents and an output format of the prompt sentence to be generated in accordance with an analysis result, and to cause the generative information processing model to create optimized travel plan information by using the prompt sentence generated by the prompt generation function unit.

What is claimed is:

1. A system comprising:
circuitry configured to:
receive, via a communication interface coupled to a packet-switched network, structured input data from a terminal device, the structured input data comprising condition data and at least one count parameter;
store the structured input data in a storage device coupled to the circuitry;
generate, based on the structured input data, a token sequence by inserting elements of the structured input data into a sentence template having predetermined positions; and
transmit the token sequence to a trained neural network model and receive, from the trained neural network model, generated output data, and transmit the generated output data to the terminal device via the communication interface.

2. The system according to claim 1, wherein the circuitry is further configured to normalize the structured input data into a normalized structured record by converting heterogeneous data formats of the structured input data into a unified representation prior to generating the token sequence.

3. The system according to claim 2, wherein the circuitry is further configured to generate, based on the normalized structured record, a structured data set comprising a plurality of data elements, each data element corresponding to a temporal division of the generated output data.

4. The system according to claim 3, wherein the structured data set further comprises location identifiers and mode identifiers associated with each temporal division, and wherein the circuitry generates the token sequence by mapping the location identifiers and mode identifiers to corresponding predetermined positions within the sentence template.

5. The system according to claim 4, wherein the condition data comprises schedule information specifying a date range, and the at least one count parameter specifies a number of participants, and wherein the circuitry encodes the date range and the number of participants as constraint fields within the structured data set.

6. The system according to claim 5, wherein the circuitry is further configured to receive, from the terminal device, transportation preference data specifying a preferred conveyance type, and to insert the preferred conveyance type into a corresponding predetermined position of the sentence template.

7. The system according to claim 1, wherein the circuitry is further configured to convert the generated output data from the trained neural network model into a hierarchical structured data format comprising a plurality of nested data objects organized by temporal divisions.

8. The system according to claim 7, wherein each nested data object comprises at least an activity data field, a location data field, and a time allocation data field.

9. The system according to claim 8, wherein the circuitry is further configured to parse the generated output data by identifying delimiter tokens in the generated output data and mapping segments between delimiter tokens to corresponding data fields of the nested data objects.

10. The system according to claim 9, wherein the circuitry is further configured to validate the hierarchical structured data format against the structured input data by comparing temporal constraints in the condition data with time allocation data fields in the nested data objects and flagging inconsistencies.

11. The system according to claim 10, wherein the hierarchical structured data format further comprises lodging candidate data fields and cost estimation data fields associated with each temporal division.

12. The system according to claim 1, wherein the circuitry is further configured to receive, from the terminal device via the communication interface, correction input data identifying a modification to the generated output data, and to generate an updated token sequence incorporating the correction input data by modifying at least one element in the sentence template.

13. The system according to claim 12, wherein the circuitry is further configured to iteratively update the generated output data by repeating a cycle of transmitting the updated token sequence to the trained neural network model, receiving updated generated output data, and transmitting the updated generated output data to the terminal device until no further correction input data is received.

14. The system according to claim 13, wherein the circuitry is further configured to store each iteration of the generated output data in the storage device as a version history and to selectively retrieve a prior version responsive to a rollback request from the terminal device.

15. The system according to claim 14, wherein the circuitry is further configured to analyze the correction input data across a plurality of iterations to identify a correction pattern and to proactively adjust subsequent token sequences based on the identified correction pattern.

16. The system according to claim 15, wherein the generated output data comprises a travel itinerary specifying at least destination information, accommodation information, activity information, and transportation mode information organized by day.

17. The system according to claim 16, wherein the circuitry is further configured to transmit, to an external information processing apparatus via the communication interface, a service request data structure generated from the travel itinerary, and to receive a service response data structure comprising availability information and cost information, and to integrate the service response data structure into the travel itinerary.

18. A system comprising:
circuitry configured to:
receive, via a communication interface coupled to a packet-switched network, structured input data from a terminal device, the structured input data comprising condition data including a date range and a location preference, a count parameter specifying a number of participants, and a conveyance preference;
normalize the structured input data into a normalized structured record stored in a storage device by converting heterogeneous data formats into a unified representation;
generate a structured data set from the normalized structured record, the structured data set comprising temporal division elements, location identifiers, mode identifiers, and constraint fields encoding the date range and the count parameter;
generate a token sequence by inserting the temporal division elements, the location identifiers, and the mode identifiers into a sentence template having predetermined positions corresponding to each data element;
transmit the token sequence to a trained neural network model comprising a transformer architecture with a plurality of self-attention layers, and receive generated output data from the trained neural network model; and
convert the generated output data into a hierarchical structured data format comprising nested data objects organized by temporal divisions, each nested data object comprising an activity data field, a location data field, a time allocation data field, and a cost estimation data field, and transmit the hierarchical structured data format to the terminal device via the communication interface.

19. The system according to claim 18, wherein the circuitry is further configured to receive correction input data from the terminal device and to iteratively regenerate the generated output data by modifying the token sequence based on the correction input data until a confirmation signal is received from the terminal device.

20. A method comprising:
receiving, via a communication interface coupled to a packet-switched network, structured input data from a terminal device, the structured input data comprising condition data and at least one count parameter;
storing the structured input data in a storage device;
generating, based on the structured input data, a token sequence by inserting elements of the structured input data into a sentence template having predetermined positions; and
transmitting the token sequence to a trained neural network model and receiving, from the trained neural network model, generated output data, and transmitting the generated output data to the terminal device via the communication interface.
